(19) United States
(12) Patent Application Publication
(10) Pub. No.: US 2018/0053274 A1
(43) Pub. Date: Feb. 22, 2018

(54) Map Centric Emergency And Field Services Management System Incorporating User Configurable Predictive Geospatial Artificial Intelligence

(71) Applicant: Burnology Pty Ltd, Hornsby (AU)

(72) Inventors: Dylan Kendall, Hornsby (AU); Martin Hedenstroem, Hornsby (AU)

(21) Appl. No.: 15/656,789

(22) Filed: Jul. 21, 2017

Related U.S. Application Data
(60) Provisional application No. 62/483,514, filed on Apr. 10, 2017.

(30) Foreign Application Priority Data
Jul. 22, 2016 (AU) 2016206397

(51) Int. Cl. G06Q 50/26; G06N 7/00; G06N 5/02

(52) U.S. Cl. CPC G06Q 50/265; G06Q 10/103; G06N 5/022; G06N 7/005

(57) ABSTRACT

A method for predicting a spatial location of a real-world phenomenon at a future time comprises: (a) receiving dependent variable data for one or more dependent variables associated with the phenomenon from an observation source, the dependent variable data being time stamped and including a geographical reference; (b) responsive to receiving the dependent variable data, collating the dependent variable data with independent variable data for one or more independent variables associated with the geographical reference and storing the collated data in a data store; (c) receiving a prediction request for predicting the spatial location of the real-world phenomenon at the future time; (d) retrieving collated data that satisfy a predefined relevance criterion; and (e) implementing an algorithm that utilises or is derived from the retrieved collated data and predicting the spatial location of the real-world phenomenon based on the output of the algorithm.

### CROSS REFERENCE TO RELATED APPLICATIONS

This application claims the benefit of U.S. Provisional Application No. 62/483,514, filed Apr. 10, 2017, and Australian Patent Application No. 2016206397, filed Jul. 22, 2016, which are both hereby incorporated by reference in their entireties.

### FIELD OF THE INVENTION

This invention relates to a map centric emergency and field services management system and corresponding method of use. It also relates to user configurable predictive geospatial intelligence techniques utilising artificial intelligence.

### BACKGROUND OF INVENTION

Every year, governments invest billions of dollars preventing and combating natural disasters such as bush fires, earthquakes and cyclones. Despite this considerable expenditure, most natural disasters are still managed using a combination of unrecorded two-way radio transmissions, paper forms, face to face meetings and informal and poorly integrated computer systems (e.g. email, spread sheets). Often, information about where and when prevention activities have been undertaken (e.g. prescribed burns to assist in the management of bushfires) is unavailable during the management of the very same incidents these prevention activities were designed to prevent. This is often due to different systems being used for prevention activities and managing emergency incidents. In addition, there is little information sharing between emergency management agencies which is significant because most emergency management is multi-agency. These approaches are considered out-dated in most other contexts.

Not only does this level of expenditure justify a higher level of accountability than is possible using current approaches, these approaches often lead to mistakes, differences in understanding of the current situation (situational awareness) between incident responders, incident managers and ultimately the public and important information being overlooked or forgotten. In addition, the current approaches result in incomplete and disjointed data sets which makes it difficult to analyse natural disaster management data for legal review, training, continuous improvement or research purposes.

The increasing frequency and impact of natural disasters and an increasingly connected and aware public is putting pressure on emergency managers to improve achievement of, and being accountable for, their legislated responsibility to minimise the adverse impacts of natural disasters on human life, property and the environment.

It would be advantageous if there was provided an emergency and field services management system that overcomes at least some of the problems associated with conventional methods (as outlined above).

### SUMMARY OF INVENTION

In accordance with a first aspect of the present invention there is provided a computer implemented system for managing a situation, comprising: an application operable to:

receive a user input including (a) spatial parameters for the situation and (b) a selection of a predefined map template; and
generate a map that is utilised for managing the situation, the map being generated based on the spatial parameters and selected predefined map template, wherein for each predefined map template there is at least one corresponding feature type having one or more user selectable states.

In an embodiment the application is operable to provide a user interface allowing the user to enter the spatial parameters and select the predefined template from a list of selectable templates, each of the selectable templates being associated with at least one predefined type of situation.

In an embodiment the application is further operable to store the generated map in a data repository which is uniquely associated with the situation.

In an embodiment the data repository is stored in a cloud database.

In an embodiment the generated map is accessible by multiple users that are assisting with the situation, via the application.

In an embodiment the application is operable to receive situation information from each of the multiple users and wherein the information is stored in the data repository.

In an embodiment the situation information comprises feature data associated with a features plotted by a user on the map, using the application.

In an embodiment the feature data comprises a feature type and corresponding feature state, and wherein only one feature state can be selected by the multiple users at any one time.

In an embodiment features plotted on the map are represented by unique symbols that can be seen by each of the users.

In an embodiment the features are plotted on a specific layer of the generated map and wherein each layer and features plotted thereon can be turned on or off by individual users.

In an embodiment each of the feature states are associated with one or more rules implemented by the application.

In an embodiment the rules govern a behaviour of the state once it has been plotted.

In an embodiment the rules determine the behaviour of the state over time or in response to rule governing data accessible by the application.

In an embodiment the rules determine whether a user can modify or delete a currently recorded state based on rule governing data accessible by the application, such that any changes of state are shown in real or near real time to any other users accessing the same map.

In an embodiment the application is further operable to determine a newly plotted feature on the generated map and include a corresponding feature on one or more other maps stored by the system that are associated with the same spatial parameters, based on one or more rules implemented by the application.

In an embodiment the application is operable to determine a change to the state of a feature plotted on the generated map and update a state associated with a corresponding feature on one or more other maps stored by the system that are associated with the same spatial parameters, based on one or more rules implemented by the application.

In an embodiment the one or more other maps are target maps, each target map being created via the application for managing one of a pre-planned or un-planned situation.

In an embodiment the application is operable to determine a change of a feature state on the target map and update the corresponding feature state on the generated map, based on one or more rules implemented by the application.

In an embodiment the system comprises a knowledge base configured to store situation data for all situations managed by the application, and wherein the data stored by the knowledge base is automatically available for inclusion on any generated or target map.

In an embodiment the situation data is manually entered by users of the application.

In an embodiment the situation data includes data received from external systems that are communicable with the computer implemented system.

In an embodiment the application is further operable to determine a format of the situation data received from the external system(s) and, if the determined format is different to a native system format, convert the received data to the native system format.

In an embodiment the conversion comprises filtering the situation data prior to using one or more schemas for converting the data to the native system format.

In an embodiment the native system format is mySQL.

In an embodiment the conversion is performed in real time.

In an embodiment the system is hierarchical and includes a plurality of user levels.

In an embodiment data received from a user at a lower of the levels is collated and stored using a predefined template for accessing by users at a higher level.

In an embodiment the data includes data associated with multiple maps that are created by the application.

In an embodiment the data includes data received from users while collaborating on situations associated with the respective maps.

In accordance with a second aspect there is provided a computer implemented system for managing a situation, comprising:

an application operable to: generate a map as described above in accordance with the first aspect, and make the generated map available to one or more other users that are accessing the system, such that modifications made by any of the users to feature related data associated with the map that are communicated to each of the other users in real or near real time over a communications network.

In an embodiment the users access the application via a user computing device and wherein responsive to a user computing device being unable to establish communication with the system any modifications to feature related data made by the corresponding user is stored by the device and communicated to the system once communication has been re-established.

In an embodiment modifications made by other users during the period that the device was unable to establish communication are stored by the system and communicated to the device once it has re-established communication.

In accordance with a third aspect of the present invention there is provided a method for managing a situation, comprising: an application stored on a computer readable medium and comprising one or more instructions which, when executed by a computer system, is operable to: receive a user input including (a) spatial parameters for the situation and (b) a selection of a predefined map template; and generate a map that is utilised for managing the situation, the map being generated based on the spatial parameters and selected predefined map template. For each predefined map template there may be at least one corresponding feature type having one or more user selectable states.

In accordance with a fourth aspect there is provided a method for predicting a spatial location of a real-world phenomenon at a future time, the method comprising: (a) receiving dependent variable data for one or more dependent variables associated with the phenomenon from an observation source, the dependent variable data being time stamped and including a geographical reference; (b) responsive to receiving the dependent variable data, collating the dependent variable data with independent variable data for one or more independent variables associated with the geographical reference and storing the collated data in a data store; (c) receiving a prediction request for predicting the spatial location of the real-world phenomenon at the future time; (d) retrieving collated data that satisfy a predefined relevance criterion; and (e) implementing an algorithm that utilises or is derived from the retrieved collated data and predicting the spatial location of the real-world phenomenon based on the output of the algorithm.

In an embodiment the predefined relevance criterion is that the collated data comprises independent variable data associated with a current state of the real-world phenomenon.

In an embodiment the predefined relevance criterion is that the collated data comprises one or more of the same independent variables determined to be present at, or located within a predefined distance of, the current location of the real-world phenomenon.

In an embodiment the algorithm utilises or is additionally derived from a value and/or type of the independent variables at the current location of the real-world phenomenon.

In an embodiment the method further comprises evaluating one or more independent variables associated with the predicted spatial location and updating the prediction based thereon.

In an embodiment the step of updating the prediction comprises re-implementing the algorithm utilising collated data associated with the one or more independent variables for the predicted spatial location.

In an embodiment the method further comprises receiving real time dependent variable data from an observation source for a current state of the real-world phenomenon and updating the prediction based on the real time dependent variable data.

In an embodiment the method further comprises repeating steps (a) and (b) for additional dependent variable data for the real-world phenomenon received from the or another observation source.

In an embodiment the method further comprises (f) processing the stored collated data to determine relationships between the geographically associated dependent and independent variables and wherein the implemented algorithm is derived from the relationships.

In an embodiment step (f) is implemented each time additional dependent variable data is received from the or another observation source.

In an embodiment the independent variables comprise at least one of a spatial, non-spatial and temporal independent variable type determined to be at, or within a predefined proximity of, the geographical reference.

In accordance with a fifth aspect there is provided a method for predicting a time at which a real-world phenomenon will arrive at a predefined spatial location, the method comprising: (a) receiving dependent variable data for one or more dependent variables associated with the phenomenon from an observation source, the dependent variable data being time stamped and including a geographical reference; (b) responsive to receiving the dependent variable data, collating the dependent variable data with independent variable data for one or more independent variables associated with the geographical reference and storing the collated data in a data store; (c) receiving a prediction request for predicting the time at which the real-world phenomenon will arrive at the predefined spatial location; (d) retrieving collated data that satisfy a predefined relevance criterion; and (e) implementing an algorithm that utilises or is derived from the retrieved collated data and predicting the time based on the output of the algorithm.

In an embodiment the predefined relevance criterion is that the collated data comprises independent variable data associated with a current state of the real-world phenomenon.

In an embodiment the predefined relevance criterion is that the collated data comprises one or more of the same independent variables determined to be present at, or located within a predefined distance of, the current location of the real-world phenomenon.

In an embodiment the algorithm utilises or is additionally derived from a value and/or type of the independent variables at the current and/or predefined spatial location of the real-world phenomenon.

In an embodiment the method further comprises evaluating one or more independent variables associated with the predicted time and updating the prediction based thereon.

In an embodiment the method further comprises the step of updating the prediction comprises re-implementing the algorithm utilising collated data associated with the one or more independent variables for the predicted time.

In an embodiment the method further comprises receiving real time dependent variable data from an observation source for a current state of the real-world phenomenon and updating the prediction based on the real time dependent variable data.

In an embodiment the method further comprises repeating steps (a) and (b) for additional dependent variable data for the real-world phenomenon received from the or another observation source.

In an embodiment the method further comprises (f) processing the stored collated data to determine relationships between the geographically associated dependent and independent variables and wherein the implemented algorithm is derived from the relationships.

In an embodiment step (f) is implemented each time additional dependent variable data is received from the or another observation source.

In an embodiment the independent variables comprise at least one of a spatial, non-spatial and temporal independent variable type determined to be at, or within a predefined proximity of, the geographical reference.

In accordance with a sixth aspect there is provided a method for predicting a time at which a real-world phenomenon will change from a first state to a predefined second state, the method comprising: (a) receiving dependent variable data for one or more dependent variables associated with the phenomenon from an observation source, the dependent variable data being time stamped and including a geographical reference; (b) responsive to receiving the dependent variable data, collating the dependent variable data with independent variable data for one or more independent variables associated with the geographical reference and storing the collated data in a data store; (c) receiving a prediction request for predicting the time at which the real-world phenomenon will change state; (d) retrieving collated data that satisfy a predefined relevance criterion; and (e) implementing an algorithm that utilises or is derived from the retrieved collated data and predicting the time based on the output of the algorithm.

In an embodiment the predefined relevance criterion is that the collated data comprises independent variable data associated with the current state of the real-world phenomenon.

In an embodiment the predefined relevance criterion is that the collated data comprises one or more of the same independent variables determined to be present at, or located within a predefined distance of, the current location of the real-world phenomenon.

In an embodiment the algorithm utilises or is additionally derived from a value and/or type of the independent variables associated with the current state of the real-world phenomenon.

In an embodiment the method further comprises evaluating one or more independent variables associated with the real world phenomenon at the predicted time.

In an embodiment the step of updating the prediction comprises re-implementing the algorithm utilising collated data associated with the one or more independent variables for the predicted time.

In an embodiment the method further comprises receiving real time dependent variable data from an observation source for the current state of the real-world phenomenon and updating the prediction based on the real time dependent variable data.

In an embodiment the method further comprises repeating steps (a) and (b) for additional dependent variable data for the real-world phenomenon received from the or another observation source.

In an embodiment the method further comprises (f) processing the stored collated data to determine relationships between the geographically associated dependent and independent variables and wherein the implemented algorithm is derived from the relationships.

In an embodiment step (f) is implemented each time additional dependent variable data is received from the or another observation source.

In an embodiment the independent variables comprise at least one of a spatial, non-spatial and temporal independent variable type determined to be at, or within a predefined proximity of, the geographical reference.

In accordance with a seventh aspect there is provided a method for predicting the presence or absence of a spatial phenomenon at a future time, the method comprising: (a) receiving dependent variable data for one or more dependent variables associated with the phenomenon from an observation source, the dependent variable data being time stamped and including a geographical reference; (b) responsive to receiving the dependent variable data, collating the dependent variable data with independent variable data for one or more independent variables associated with the geographical reference and storing the collated data in a data store; (c) receiving a prediction request for predicting the presence or absence of the real world phenomenon at the predefined time; (d) retrieving collated data that satisfy a predefined relevance criterion; and (e) implementing an algorithm that utilises or is derived from the retrieved collated data and predicting the presence or absence based on the output of the algorithm.

In an embodiment the predefined relevance criterion is that the collated data comprises independent variable data associated with a current state of the real-world phenomenon.

In an embodiment the predefined relevance criterion is that the collated data comprises one or more of the same independent variables determined to be present at, or located within a predefined distance of, the current location of the real-world phenomenon.

In an embodiment the algorithm utilises or is additionally derived from a value and/or type of the independent variables at the current spatial location of the real-world phenomenon.

In an embodiment the method further comprises evaluating one or more independent variables associated with the predefined time and updating the prediction based thereon.

In an embodiment the step of updating the prediction comprises re-implementing the algorithm utilising collated data associated with the one or more independent variables for the predefined time.

In an embodiment the method further comprises receiving real time dependent variable data from an observation source for a current state of the real-world phenomenon and updating the prediction based on the real time dependent variable data.

In an embodiment the method further comprises repeating steps (a) and (b) for additional dependent variable data for the real-world phenomenon received from the or another observation source.

In an embodiment the method further comprises (f) processing the stored collated data to determine relationships between the geographically associated dependent and independent variables and wherein the implemented algorithm is derived from the relationships.

In an embodiment step (f) is implemented each time additional dependent variable data is received from the or another observation source.

In an embodiment the independent variables comprise at least one of a spatial, non-spatial and temporal independent variable type determined to be at, or within a predefined proximity of, the geographical reference.

In accordance with an eighth aspect there is provided a method for predicting the density of a spatial phenomenon at a future time and/or location, the method comprising: (a) receiving dependent variable data for one or more dependent variables associated with the phenomenon from an observation source, the dependent variable data being time stamped and including a geographical reference; (b) responsive to receiving the dependent variable data, collating the dependent variable data with independent variable data for one or more independent variables associated with the geographical reference and storing the collated data in a data store; (c) receiving a prediction request for predicting the presence or absence of the real world phenomenon at the predefined time; (d) retrieving collated data that satisfy a predefined relevance criterion; and (e) implementing an algorithm that utilises or is derived from the retrieved collated data and predicting the density based on the output of the algorithm.

### BRIEF DESCRIPTION OF THE DRAWINGS

Features and advantages of the present invention will become apparent from the following description of embodiments thereof, by way of example only, with reference to the accompanying drawings, in which:

FIG. 1 is a schematic block diagram illustrating a system in which an embodiment can be implemented;

FIG. 2 shows the relationship between different hierarchical levels in the system, in accordance with an embodiment;

FIG. 3 shows various audiences that may be served by the system, in accordance with an embodiment;

FIG. 4 is an example conversion process carried out by the data integration engine, in accordance with an embodiment;

FIG. 5 shows a process flow for creating a shared map, in accordance with an embodiment;

FIG. 6 schematically shows parts of the process flow of FIG. 5;

FIG. 7 is a schematic illustrating template definitions, in accordance with an embodiment;

FIG. 8 schematically illustrates steps for triggering a rule and implementing a corresponding action, in accordance with an embodiment;

FIG. 9 shows example screen shots serving to illustrate contextual rule behaviour, in accordance with an embodiment;

FIG. 10 is a schematic illustrating relationships between two different map types, in accordance with an embodiment of the present invention;

FIG. 11 is a schematic illustrating high level functionality of the geospatial intelligence engine, in accordance with an embodiment;

FIGS. 12A to 12H show various example relationships between source and target maps;

FIGS. 13A to 13J show various example trigger conditions for behavioural rules;

FIGS. 14A and 14B schematically illustrate a source to target map feature copy and feature convert behaviour, respectively;

FIGS. 15A to 15D illustrate various target map behaviours, in accordance with an embodiment;

FIGS. 16A and 16B illustrate various advanced target map behaviours, in accordance with an embodiment;

FIGS. 17, 18, and 19 schematically illustrate offline functionality, in accordance with an embodiment;

FIG. 20 is a process flow diagram for predicting a spatial phenomenon in accordance with an embodiment;

FIG. 21 is a diagram showing an example interface for plotting a dependent variable, in accordance with an embodiment;

FIG. 22 is a diagram showing an example schematic for predicting fire rate of movement;

FIGS. 23A and 23B are diagrams showing a current and predicted location of a fire edge, respectively;

FIG. 24 is a diagram showing a predicted flame height over time;

FIGS. 25A and 25B are diagrams showing a new road change from planned to completed;

FIG. 26 is a diagram showing an example output for predicting the presence/absence of a dependent variable;

FIG. 27 is a diagram showing an example output for predicting the density of a dependent variable;

FIG. 28A shows example independent variables under a current scenario and FIG. 28B shows the predicted dependent variable at a future time, using predefined equations;

FIG. 29A shows example independent variables under a current scenario and FIG. 29B shows the predicted dependent variable at a future time, using an on the fly calculation;

FIG. 30A shows example independent variables under a current scenario and FIG. 30B shows a predicted dependent variable zone at a future time;

FIGS. 31A and 31B are diagrams illustrating an example averaging method prediction;

FIGS. 32A, 32B and 32C are diagrams illustrating an example historical cases prediction method for predicting presence/absence of a dependent variable;

FIGS. 33A, 33B and 33C are diagrams illustrating an example historical cases prediction method for predicting density of a dependent variable;

FIGS. 34A, 34B and 34C are diagrams illustrating an example historical cases prediction method for predicting the time a dependent variable was present;

FIG. 35 is a diagram illustrating feedback incorporation;

FIGS. 36A, 36B and 36C are diagrams illustrating prediction correction utilising feedback;

FIGS. 37A and 37B are diagrams illustrating prediction correction utilising feedback;

FIGS. 38A and 38B are diagrams showing a 2-dimensional approach for making predictions;

FIG. 39 is a diagram showing a 1-dimensional approach for making predictions;

FIGS. 40A to 40D show example hierarchical methods for prediction;

FIGS. 41A to 41D are diagrams illustrating optional analysis for prediction;

FIGS. 42A and 42B are diagrams illustrating maximum and minimum analysis for dependent variable prediction;

FIG. 43 includes diagrams for providing reliability information for predictions;

FIGS. 44A to 44D show example sensitivity analysis methods for prediction;

FIGS. 45A to 45D show example adjustment methods for prediction;

### DETAILED DESCRIPTION

The present invention relates to a system, and corresponding method of use, that is particularly suited for facilitating the management of emergencies and field services. Accordingly, embodiments of the present invention are described in such a context below. However, it will be understood that the system can equally be used in a wide range of sectors where there is a requirement to: manage geographically separated field individuals/teams; manage a particular spatial phenomenon; and/or manage a situation having a multiple hierarchical structure.

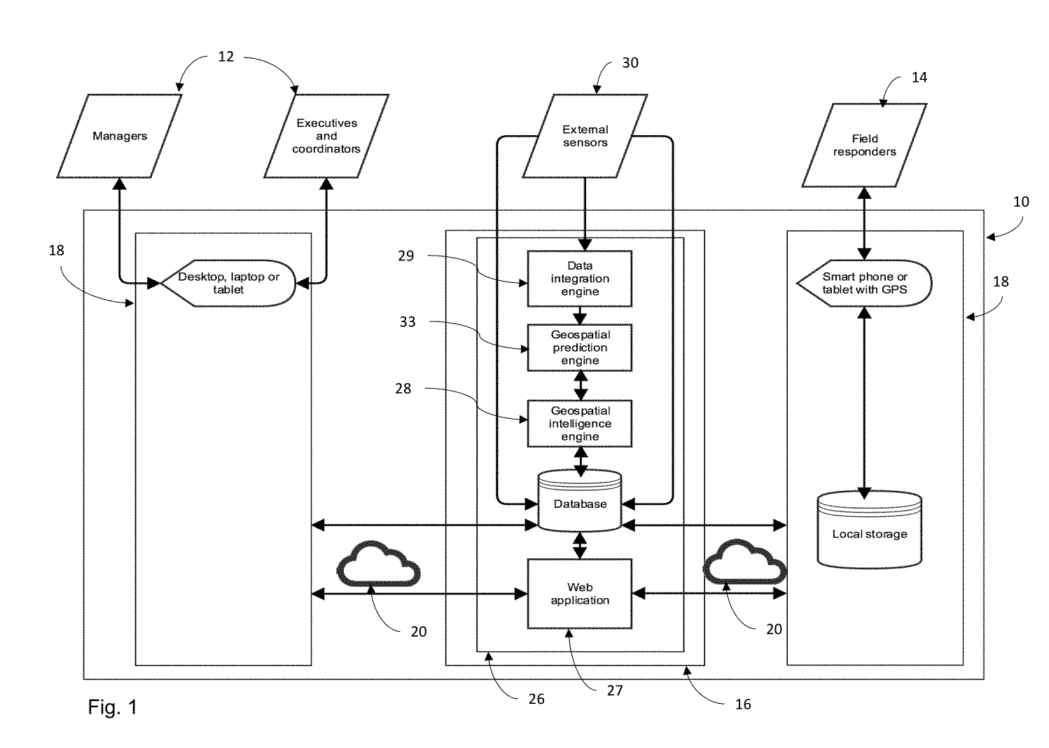

With reference to FIG. 1 there is shown a schematic of a system 10 for carrying out an embodiment of the present invention.

According to the illustrated embodiment, the system 10 is configured to be used by geographically separated teams and individuals, including office-based users 12 and field-based users 14. In this regard, the system 10 comprises a collaboration system 16 implementing a computer program (in this instance taking the form of a web or “cloud based” application 27) that allows the users 12, 14 to collaborate for managing a particular situation. Such collaboration includes the ability to create, modify and share situation specific information including maps and corresponding map feature data. In addition, the system 10 can advantageously utilise the shared situation specific information to make predictions about spatial related phenomenon that can be used to effectively manage the situation. These functions will be described in more detail in subsequent paragraphs.

Users access the web application 27 via a suitably configured user computing device 18. According to the illustrated embodiment, office-based users 12 utilise a personal computer for accessing the web application 27, whereas the field based users 14 utilise a smartphone. It will be appreciated, however, that the actual device used by the users 12, 14 may take the form of any suitably configured computing device (e.g. laptop, tablet, PDA, etc.) that is capable of communicating with the collaboration system 16 for accessing the web application 27.

As shown in FIG. 1, the user devices 18 are communicable with the collaboration system 16 over a communications network 20. More particularly, the field based user devices 18 communicate with the system 16 via a data communications network, which in the illustrated embodiment takes the form of the Internet. Although not illustrated in FIG. 1, the field devices 18 are communicable with the Internet via a broadband mobile network including standard network elements including a base station controller, home location register, mobile switching centre, message centre, equipment identity register, message gateway, etc. In an alternative embodiment, the devices 18 may be configured to communicate with the network 20 via a satellite communications or radio network (not shown).

In more detail, the collaboration system 16 comprises a web server 26 which is operable to implement the web application 27. In addition, the server 26 implements a number of engines. A first engine 29 (hereafter “data integration engine”) is operable to convert data received from one or more external systems 30 into a native data format that can be used by the web application 27. The server 24 also implements a second engine 31 (hereafter “geo-spatial intelligence engine”) that, generically, is operable to add data from one map (the source map) to other maps (target maps), based on predefined rules (i.e. giving users the impression that the system 10 ‘learns’ over time or has artificial intelligence). A third engine in the form of a user configurable geospatial prediction engine 33 is provided for predicting spatial related phenomena related to the situation being managed. The functions performed by the engines 29, 31 and 33 will be described in more detail in subsequent paragraphs.

A database 28 stores the various engine data input/output, as well as all current and historical data received from users of the web application 27 while collaborating on a particular situation. According to a particular embodiment, maps that are created using the web application 27 are stored in an object library in association with information identifying the corresponding situation.

### System Hierarchy

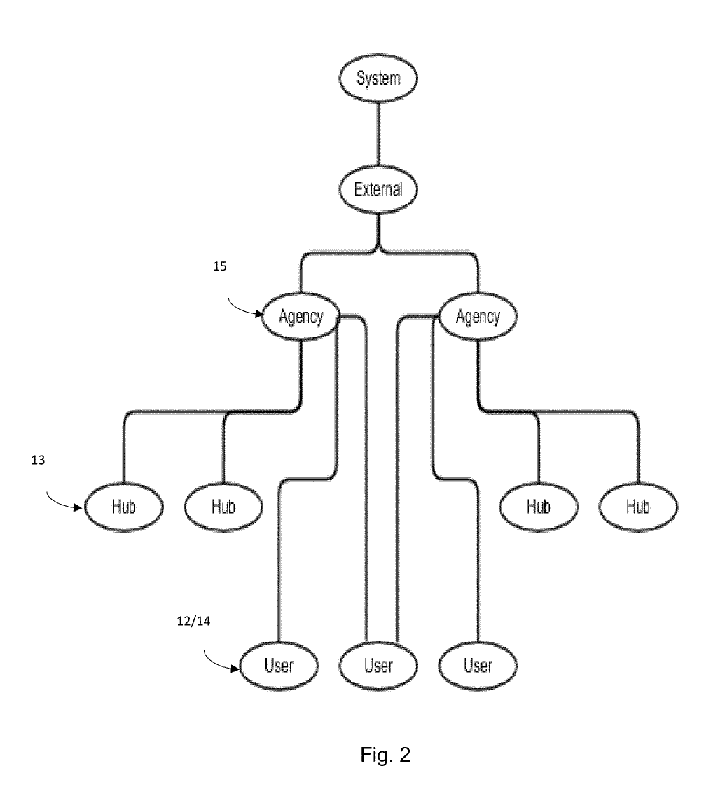

The system 10 is hierarchical and provides functionality at multiple different levels, as will now be described with reference to FIG. 2.

According to the illustrated embodiment, there are three distinct levels in the hierarchy:
Level 3: External (e.g.: the public, other agencies)
Level 2: Agency (including both co-ordinators and executives)
Level 1: Hub

It will be understood that a user may belong to more than one agency (although this would be unusual) and that there may be multiple users 12, 14 and hubs 13 per agency 15.

The information available at each level is derived by the web application 27 by automatically collating and summarising data collected at a lower hierarchical level, with the individual user in a hub (which may either be an office-based user 12 or field-based user 14), being the ultimate source of all data. In this way, situation data is entered into the system 10 once (often in the form of changing a map, as will be described in subsequent paragraphs) and re-used to meet the needs of audiences operating at three different hierarchical levels.

In a particular embodiment, the web application 27 is configured to convert situation data stored in the database 28 into a predefined format for use at each hierarchical level (e.g.: from a map to a table), using conversion templates stored in the database 28. As data is entered only once and converted into different formats for different audiences, the system acts as a ‘single source of truth’ for multiple audiences (see FIG. 3 which shows a schematic of multiple audiences that may be served by the system 10).

The vast majority of data stored and accessible by the system 10 is generated by individual users in a hub 13 (i.e. when collaborating on a situation). It will be understood that the term “hub” is used to described a virtual location in which all data/information relating to a particular situation is stored (i.e. within the database 28). Each hub 13 contains a single shared map that has been generated by the application 27, as well as information related to other modules for example, messages, tasks, attachments (including images captured by mobile devices 18 but also documents) and forms that are related to that shared map. Feature related data for each hub 13 is stored in a database table in a native system format.

### Data Integration Engine

As previously mentioned, the web server 26 implements a data integration engine 29 that enables data to be imported from external systems 30 (and sensors, such as automatic weather stations, movement detection systems in the defence context, among others) and converted to the same structure/schema as the data generated inside the system 10. In this way, not only can external data be viewed using the web application 27, it can also be fully utilised when creating or modifying feature data (as described in subsequent paragraphs) on shared maps. The data integration engine may also be utilised in reverse to convert data stored inside the system 10 such that it can be ingested by external systems 30.

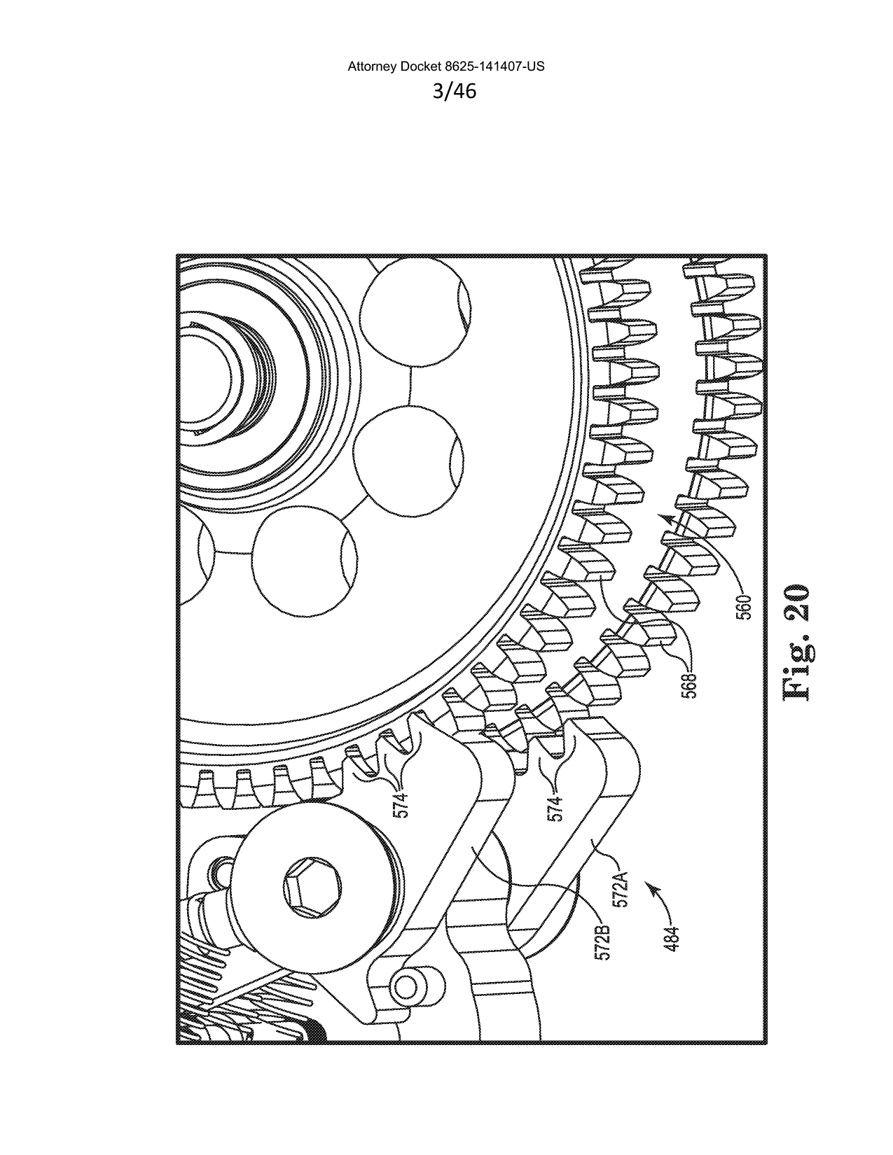

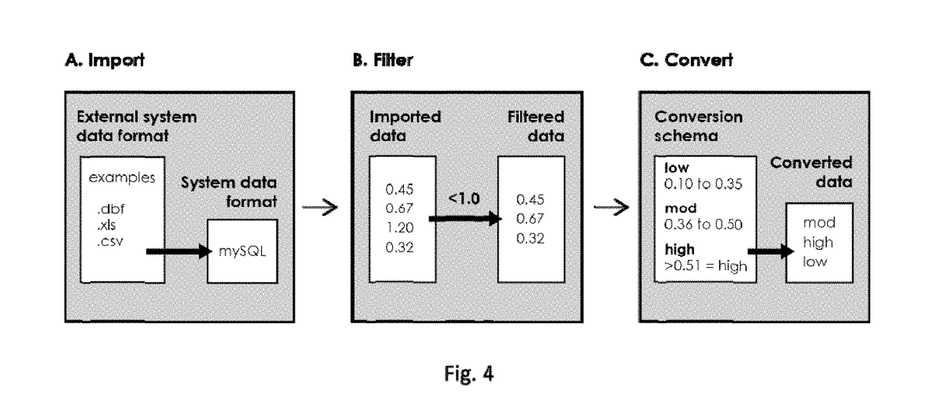

FIG. 4 shows an example conversion process carried out by the integration engine 29. The process comprises a first step (see block A “Import”) whereby the external data is converted to the same format as that used inside the system (i.e. the native system format). In a particular embodiment, the native system format is mySQL (a SQL based relational database management system) and as such the web application 27 may, for example, be written in any one of PHP, Perl, Python, Ruby, Java, C/C++, C# and Visual Basic. It will be understood, however, that the engine 29 may be configured to convert the data to any desired native system format, depending on the implementation. In a second step (block B “Filter”), the imported data is filtered so that it only contains a data range of interest. In this instance, the column containing the required data is specified, as is a filter that is used to only import data meeting specified criteria. In a third step (block C “Convert”), the filtered data is converted to the same categories/schema as used by the system 10. By way of the example shown in FIG. 4, the data in the imported column of data is converted to the schema used by the system. In this way, external data is converted to ‘native system data’.

It will be understood that the data integration engine 29 can perform once-only data integrations, or can be used to import and integrate dynamic data in real time using saved settings.

### Web Application Functionality

The various functions implemented by the web application 27 will now be described.

### Map Creation—

As previously discussed, the web application 27 is operable to create and share maps for managing a particular situation. A shared map is a map that all users logged into a hub 13 (i.e. via the web application 27) can access for viewing and editing, with such edits being visible to all users in real time. This enables real time spatial collaboration between geographically separated users 12, 14 (e.g. between users in the office and users in the field, or between geographically separated users in the field).

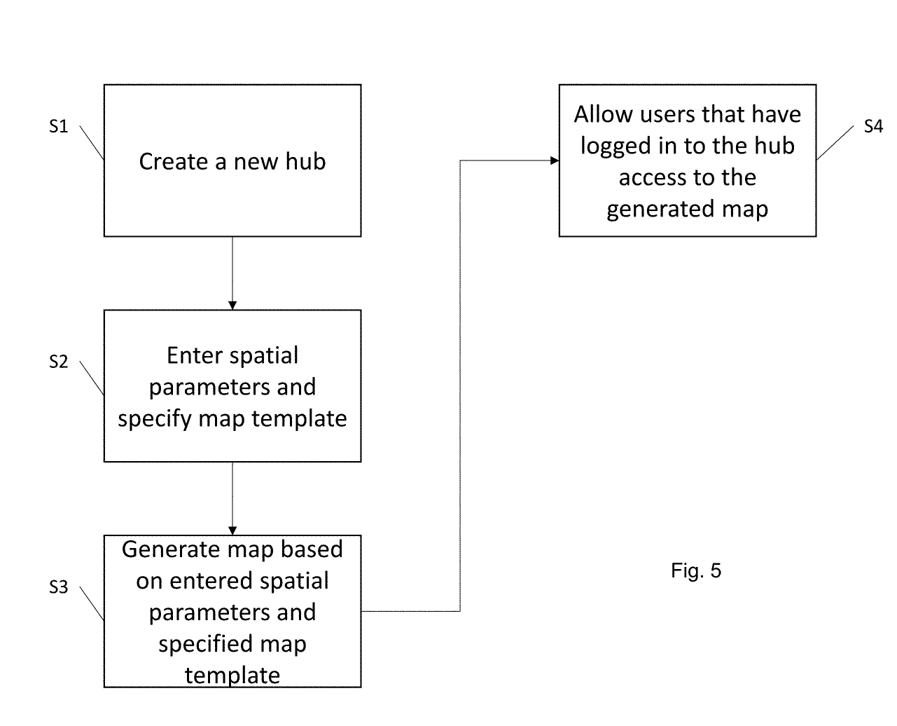

With particular reference to the flow diagram of FIG. 5, in general terms, a process of generating a map comprises a first step (step S1) of the user creating a new hub (or logging in to an existing hub) for a particular situation, via a log in interface provided by the web application 27.

At step S2, after logging into or creating a new hub, a map creation interface is displayed by the application 27, allowing the user to enter the following data:
spatial parameters for the situation
specifying a predefined map template
a name for the map.

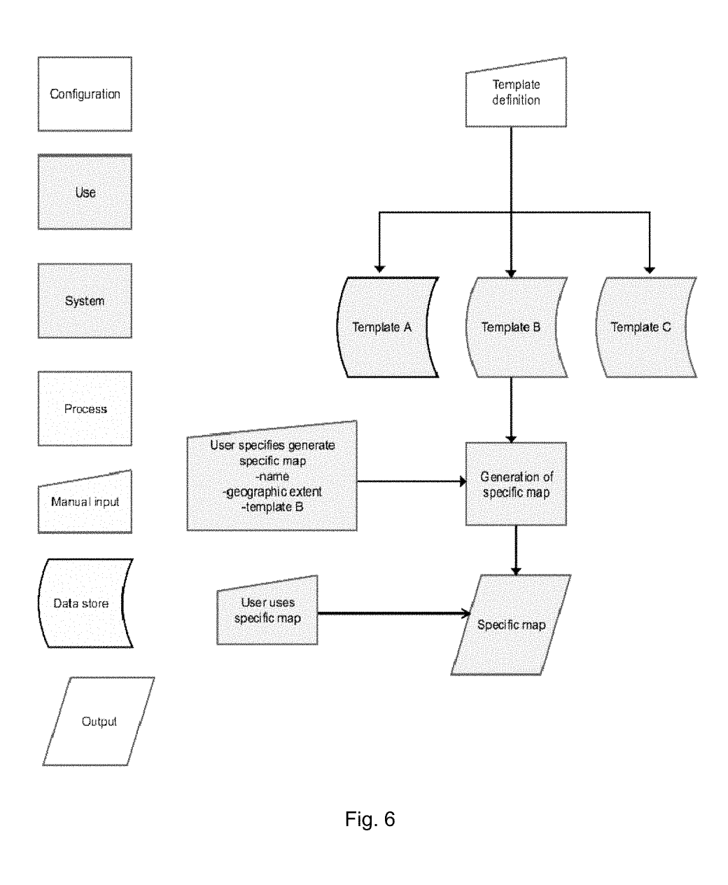

At step S3, once the above information has been entered, the application generates a map based on the spatial parameters and selected predefined map template. The generated map is stored in the corresponding hub 13 (i.e. association with the particular situation) and inherits all the characteristics of the template specified by the user. Once generated, the map can be shared among any users that is logged into the hub 13 for managing/collaborating on the specific situation (step S4). This may include creating, sharing and modifying map feature and situation specific data. The process flow is illustrated schematically in FIG. 6.

In a particular embodiment, the web application 27 is operable to create and store two types of shared map. The first is a “knowledge base” map which includes basic resource data (e.g. location of a water stand pipe, location of a toilet block, etc.) that may subsequently be of use during planned activity. The second is a “special purpose” map that is used for dealing with a particular situation, whether it be a planned situation or an unplanned activity or incident. These map types will be described in more detail in subsequent paragraphs.

### Template Definition—

In more detail, an administrator (e.g. in the end use agency) defines a number of templates 25 for different scenarios (e.g. one template for bushfires, another template for floods, etc.). Templates are defined in configuration with the behaviour of template components defined by rules.

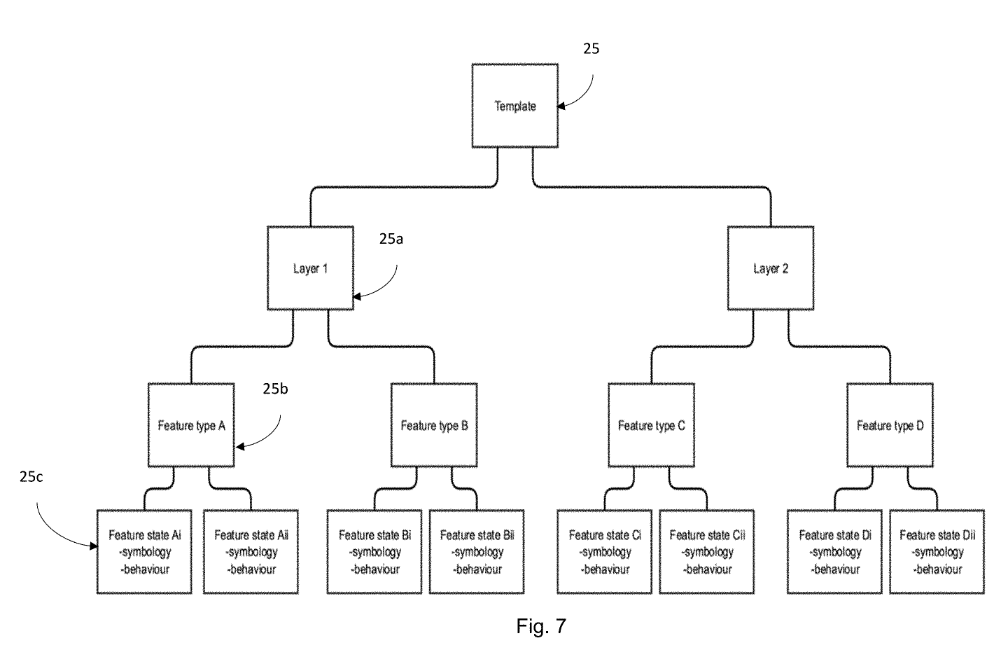

With additional reference to FIG. 7, each template 25 consists of:
One or more layers 25a (e.g. fire behaviour), with each layer consisting of:
   One or more feature types 25b (e.g. spot fire), with each feature type consisting of:
      One or more feature states 25c (e.g. suspected spot fire, confirmed spot fire)
Other non-spatial settings such as the data in dashboards and auto filled forms.

In configuration, symbology and permitted behaviour is defined for each feature state 25c. A wide range of other, non-spatial, characteristics may also be defined for each template 25 including:
Dashboard settings
Settings for generating automatically populated forms;
Settings for a resource management module;
Settings for messages and tasks; and
Settings for scoreboards.

Importantly, each feature state 25c can only occur once within a single map template 25. In this way, if a user plots, deletes or modifies a particular instance of a feature state 25c, the application 27 automatically knows which feature type and layer the change needs to be made to without this being specified by the user.

### Rules—

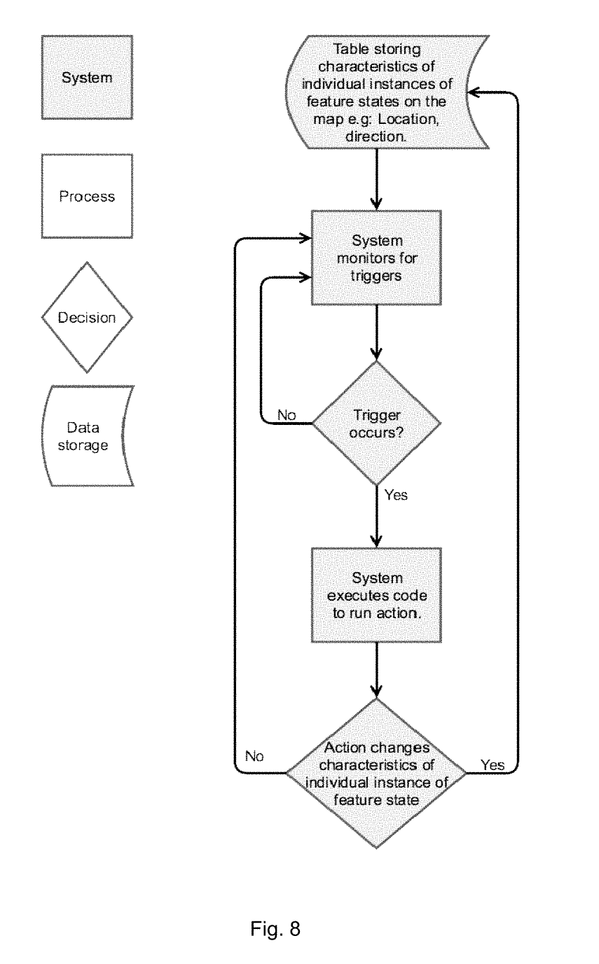

With reference to FIG. 8, the web application 27 implements one or more rules that define behaviour for each feature state. These rules are stored in a rule set and are implemented by the web application 27 to control feature behaviour, including:
whether a user can delete individual instances of that feature state 25c;
whether a user can rotate an individual instance of that feature state 25c
whether a document stored in the database 28, if any, should be automatically attached to every instance of that feature state 25c plotted by the end user
can the user specify that an alarm (alert sent to the user after a specified time has elapsed) be attached to individual instances of that feature state 25c.

Each rule consists of a trigger that defines when the rule is implemented. Triggers may include:
the end user plotting an instance of that feature state 25c (i.e. via an interface of the web application);
a specified time after the user has plotted an instance of that feature state 25c; or
the user pressing a button on an interface provided by the web application 27.

Each rule also comprises an action that is undertaken when the trigger occurs. Actions may include:
require no parameters (e.g. make a button that a user may use to implement the rule visible in the feature popup),
require input of parameters during configuration (e.g. how long a helipad specifically constructed during an emergency should remain visible);
require input of parameters by the user during use (e.g. the angle to which a feature indicating the current wind direction should be rotated);
require parameters automatically calculated by the system in real-time (e.g. use data automatically collected by the system on the average time to construct a new road to estimate how long it will take to construct a proposed road of user specified length).

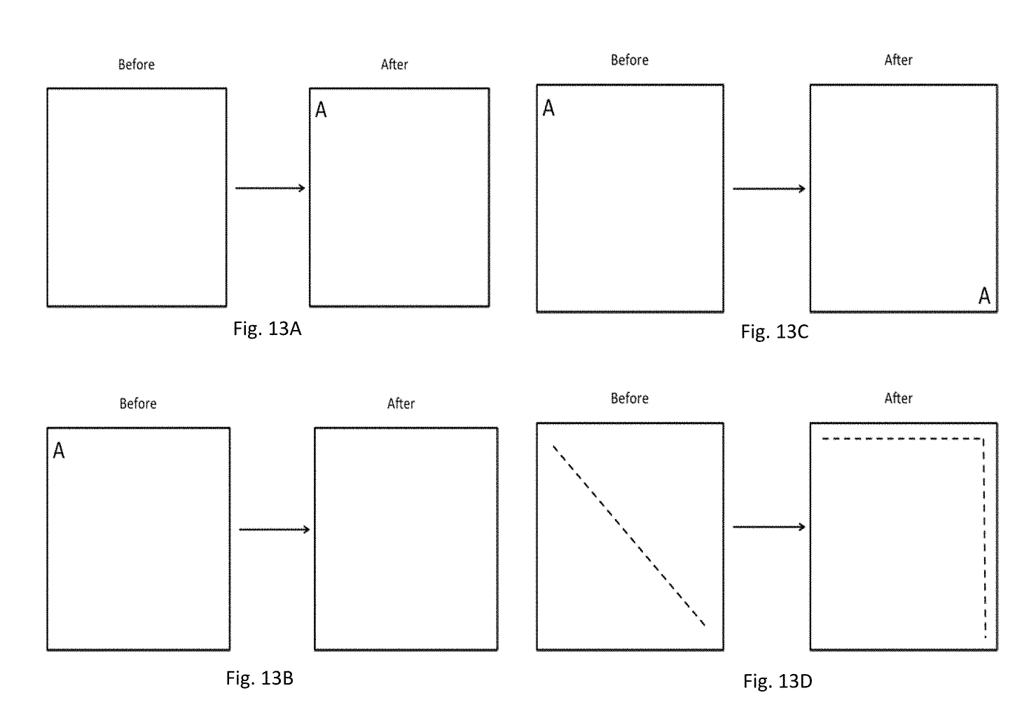

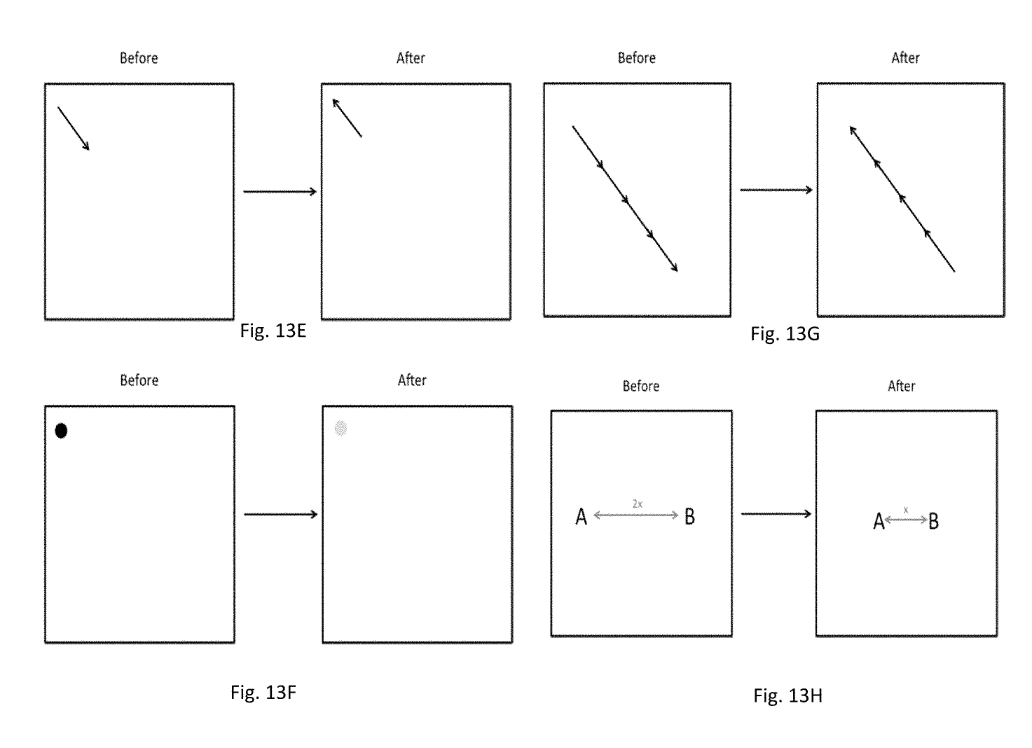

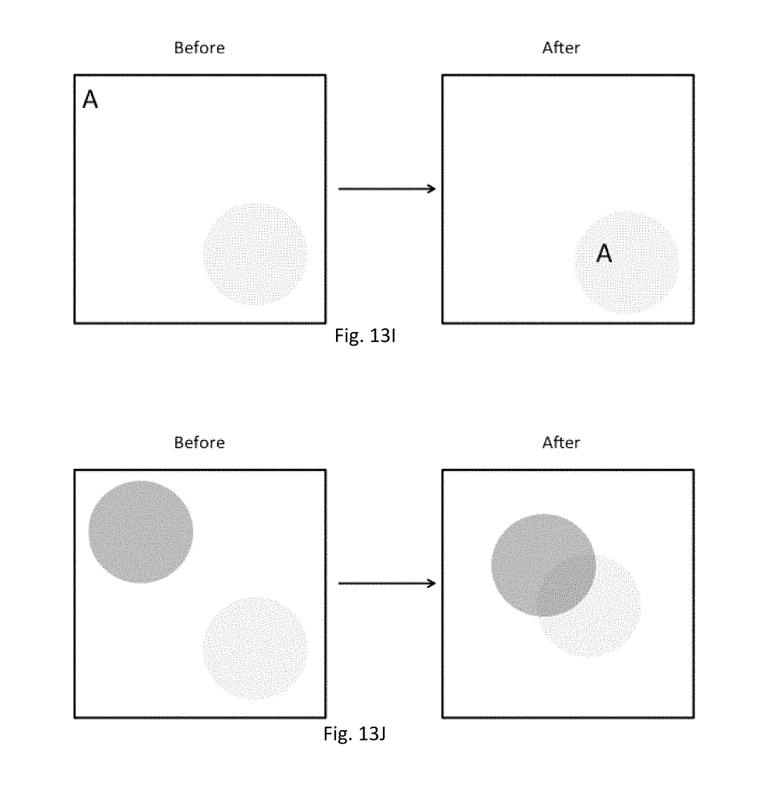

With reference to FIGS. 13A to 13J, some example trigger conditions for behavioural rules include when an instance of the feature state 25c is:
Potted (FIG. 13A);
Deleted (FIG. 13B);
Moved—i.e. by the user moving a feature or detected by GPS plotting (FIG. 13C);
Reshaped (FIG. 13D);
Rotated (rotatable point features only) (FIG. 13E);
Faded (fadable feature states only) (FIG. 13F);
Line direction reversed (line feature states where it is possible to reverse the line direction) (FIG. 13G);
Plotted or moved to within a specified distance of another specified feature state (FIG. 13H);
Plotted or moved to inside a specified polygon feature state (FIG. 13I); and
Plotted or moved to result in a specified combination of feature states (FIG. 13J).

If the trigger required to run a rule is the user selecting a button and it has been specified during configuration of the template 25 that the rule is not applicable to a particular feature state, the button required to run that rule is not visible in-use. That is, the buttons required to execute rules (if required) may be contextual, depending on the rule definition in configuration.

As well as being used to define the behaviour of feature states 25c in templates 25, rules are used for other actions, including to:
define the relationships between data to be imported and a knowledge base template 25 and therefore to define a data import schema;
define the relationship between data entered onto a specific situation (source) map and other maps (target map);
define the relationship between individual situation maps and agency dashboards and therefore what and how data added to specific situation maps is added to agency dashboards.

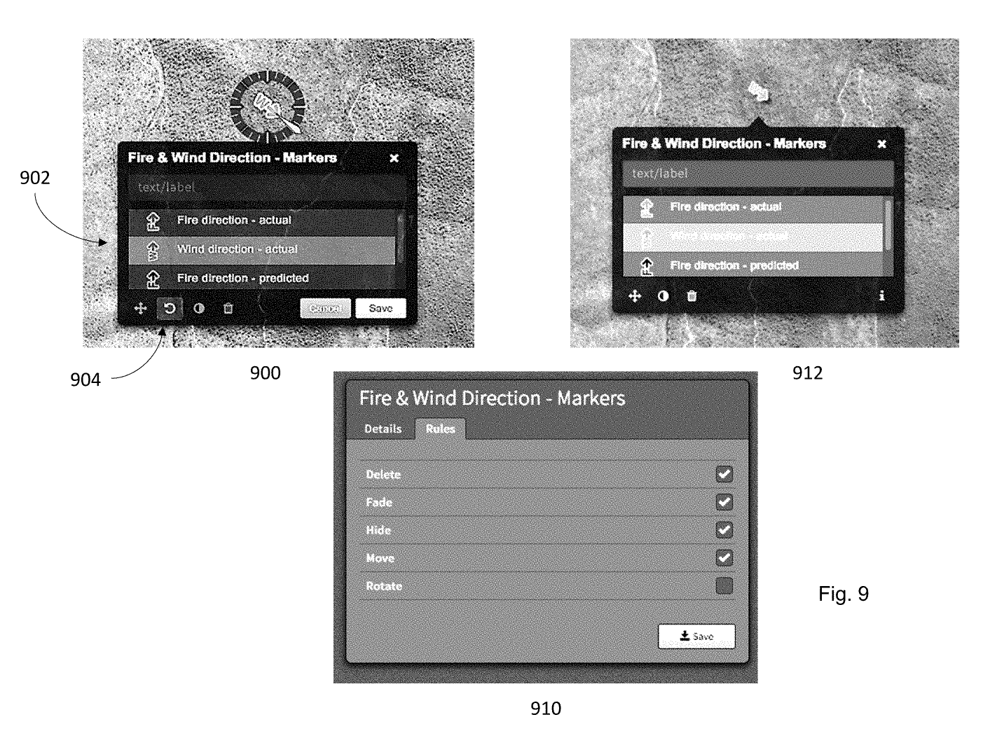

Behaviour rules can be updated by authorised users of the web application 27. For example, with reference to the example screenshot 900 of FIG. 9, there is shown a map that is presented to a user that has logged in to a hub (i.e. via the web application 27) for managing a particular situation. A feature “pop up” 902 for a particular instance of a feature state 25c (in this instance a fire and wind direction marker) shows that the corresponding feature may be rotated (see circular arrow button 904). The ability to be able to rotate this feature state is controlled by a predefined rule for the corresponding feature.

The rule that enable the feature to be rotated can be turned off by the authorised user (e.g. an agency administrator) via a setting accessible by the web application (i.e. as per screen shot 910). The result is screen shot 912 whereby the button 904 is no longer displayed in association with the state screen.

### Offline Functionality—

The system may be configured such that the afore-described map based functionality will continue to work on an individual device 16, without the user downloading software onto that device, even when that device is not connected to the Internet.

The offline functionality may be used to enable:
Users of the system to continue using the system while not connected to the Internet.
Members of the public to access public facing parts of the system when online and still be able to view data from the system if they move into an off line area.

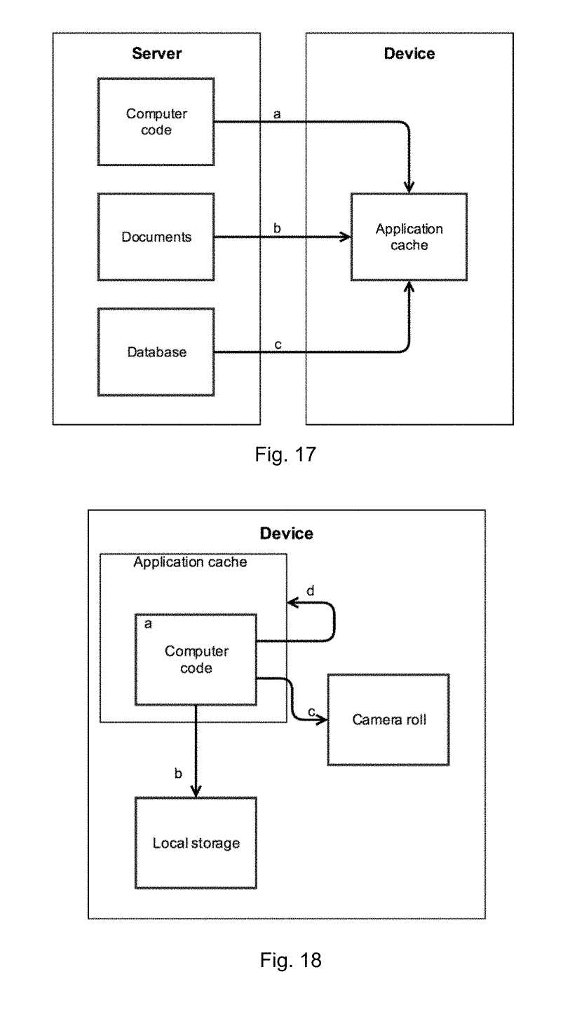

In more detail, when the device 18 is initially in an area with access to the Internet, the following steps will be carried out (also schematically represented in FIG. 17):
Computer code containing instructions for the device to run the system when off line is transferred from the web server 26 to an application cache on the device 18.
Documents and images (e.g. background maps) are transferred from the server 26 to the application cache on the device 18; and
Map features and associated data is transferred from the database 28 on the web server 26 to the application cache on the device 18.

When offline (see FIG. 18):
The computer code in the application cache is executed by a browser on the device 18, running the system when the device is offline;
New data collected when the device 18 is off line is stored in local storage in the device. This data is stored in a queue and includes a timestamp;
Photos taken when off line are stored in the camera roll of the device 18 with a reference to that photo stored in the local storage; and.
When off line, the computer code in the application cache may access the documents and images also stored in the application cache of the device 18.

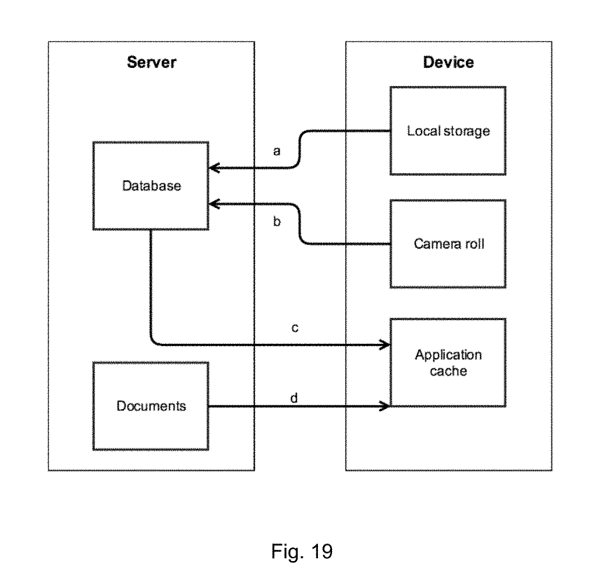

When the device 18 returns to an online area (FIG. 19):
The queued data stored in the local storage of the device 18 is copied to the database 28 on the server 26. The database 18 on the server 26 includes the time the data was collected on the individual device 16 and the time the data was copied to the database on the server 26;
Any photos referenced in the queued data on the device 18 are copied from the camera roll to the database 28 on the server 26;
Data added to the database 28 on the server 26 while the device 18 was offline is copied to the application cache on the device 18. The application continues to poll the server 26 for any changes and if a change in data is detected, the changed data is transferred from the server 26 to the application cache on the device 18; and
Any new documents and images added to the server 26 while the device 18 was offline are copied to the application cache on the device 18.

In a particular embodiment, the application 27 can estimate the position of dynamic map features (e.g. fire edge) when the device 18 is offline based on the movement of those features when the device 18 was online. This is achieved by:
When online, the application 27 uses changes in the position of a map feature to calculate the average rate of movement of that feature;
Prior to going offline, this average rate of movement is transferred from the database 28 on the server 26 to the application cache on the device 18; and
When offline, the computer code stored in the application cache continues to move the feature by the average rate of movement that was calculated and transferred when the device 18 was online.

Geospatial Intelligence Engine—

As previously mentioned, the server 26 includes a geospatial intelligence engine 31 that automatically adds data from a source map to a target map, based on rules.

The target map and the rules used are configured by an authorised user (e.g. agency administrator) on a feature state by feature state level for each map template 25.

In a particular embodiment, the relationship between the two basic map types (i.e. knowledge base map and special purpose map) is as shown in FIG. 10. It will be understood that within a single agency there may be more than one knowledge base to specific purpose map pair, and there may be more than one type of specific purpose map per knowledge base map (for example the illustrated embodiment includes two special purpose maps, one for use in pre-planned activities and another for use in unplanned activities or incidents).

For every feature state on every map template 25 the following is defined:
the source map (i.e. the current map);
the target map (together the source and target map define the map relationship);
the rule to be applied to the data between the source and target map and to the data when it is on the target map (rules may require parameters required to be entered during configuration or in-use).

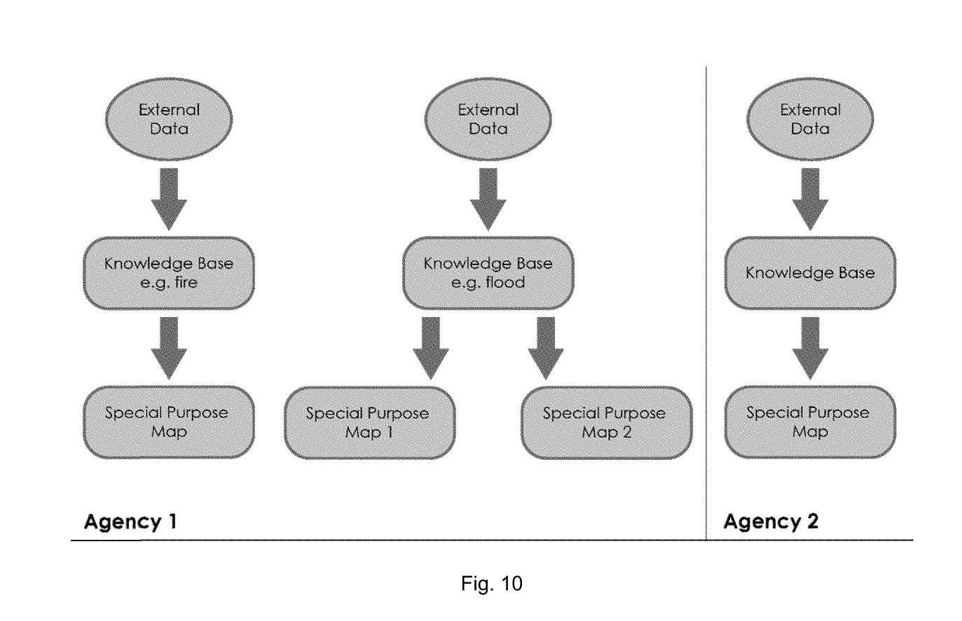

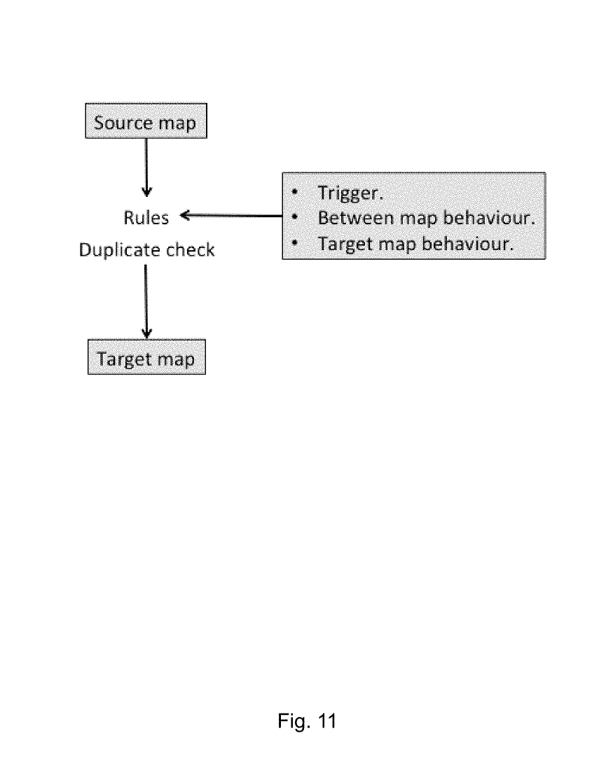

A duplicate check is also applied to ensure that duplicate features are not added to maps through this process and to ensure that infinite loops are not created, as per FIG. 11.

Each rule is defined by:
a trigger which defines when the remainder of the rule is to be applied;
between source and target behaviour which defines the behaviour of the feature between the source and target map; and
target map behaviour that defines how the feature behaves once transferred to the target map.

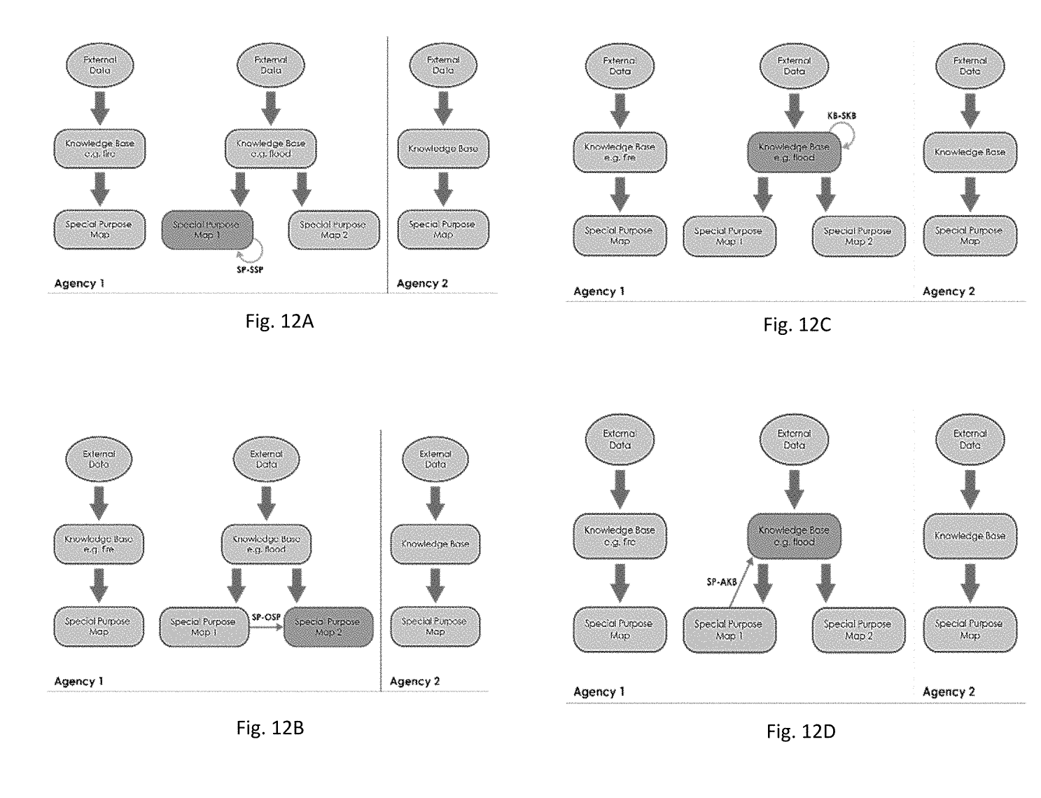

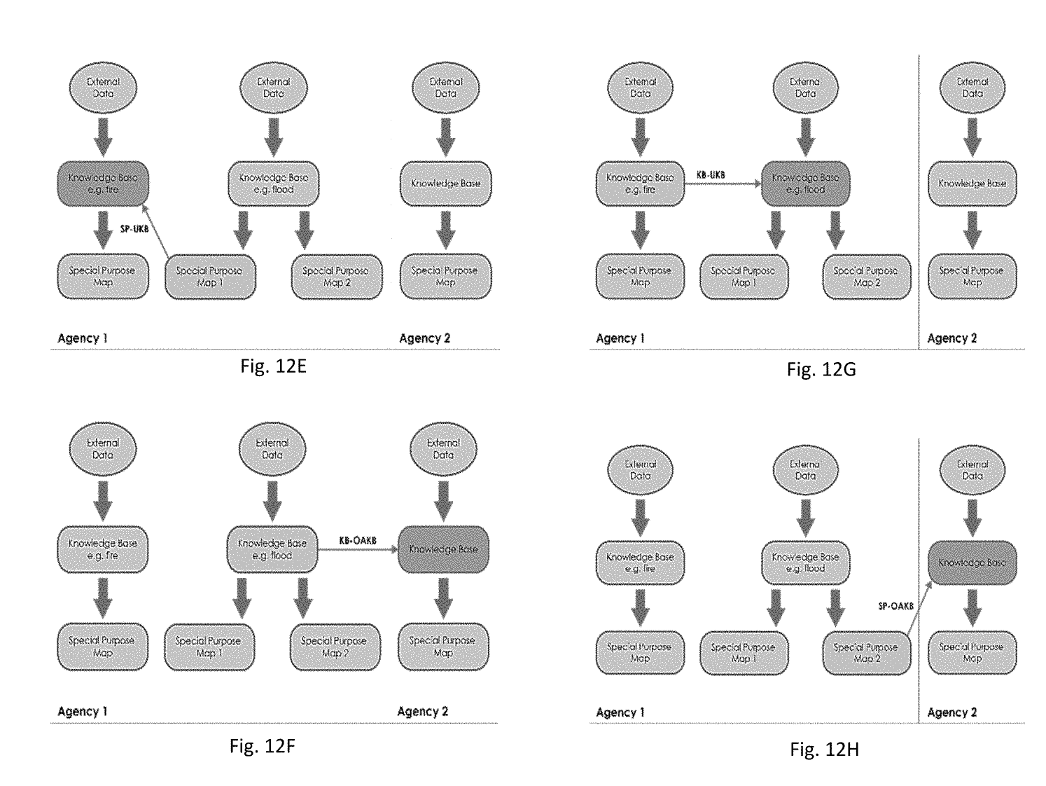

The relationships between the source and target map are located in the general map structure of the system 10. In practical terms, this involves specifying the target map when within a map template (the source map). FIGS. 12A to 12H show various relationships between source and target maps, as defined by the system 10.

By way of example, FIGS. 14A and 14B schematically illustrate a source to target map feature copy and feature convert behaviour. The copy between map behaviour can only be applied if the source and target maps both include the same feature state.

A perpetual or snapshot in time between map behaviour may be specified. If perpetual behaviour is specified, any future changes to the feature on the source map will continue to be reflected by the related feature on the target map. If the snapshot in time behaviour is specified, any future change to the feature on the source map will not result in any change to the associated feature on the target map.

As part of defining between map behaviour, the following may be specified:
transfer attachments made in configuration or change the attachment to another specified attachment between the source and target map;
transfer attachments made in-use between the source and target map; and
transfer any photos attached to the feature on the source map to the target map.

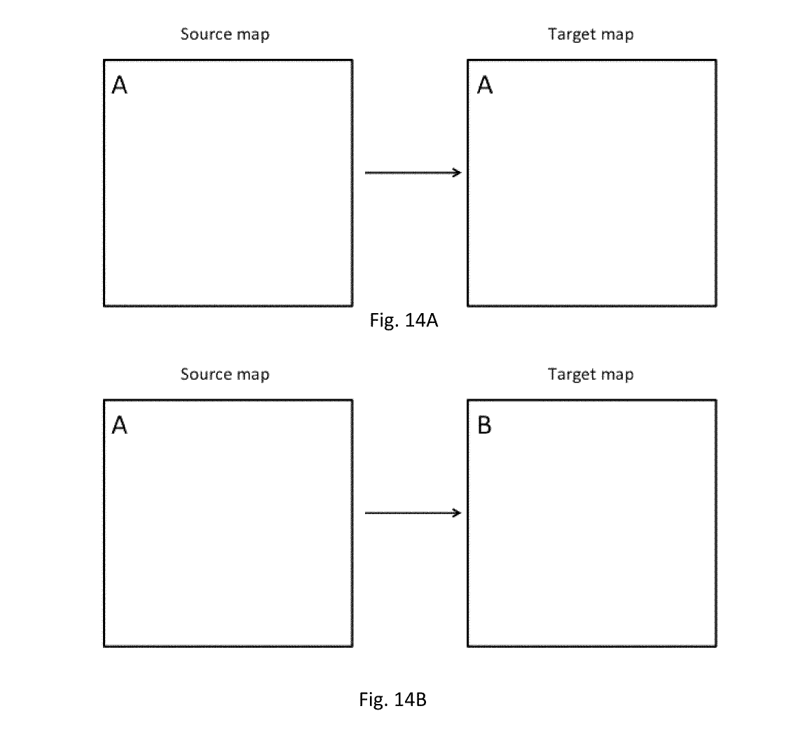

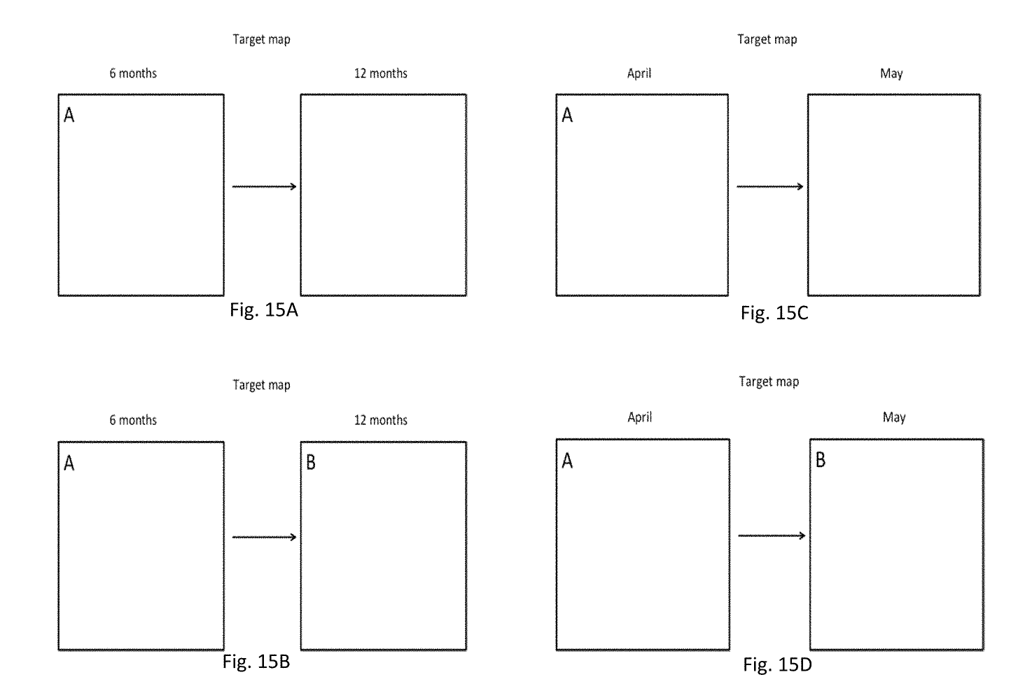

As previously mentioned, target map behaviour defines how a state 25c of feature 25b plotted on a source map behaves once it has been transferred (either copied or converted) to the target map. With reference to FIGS. 15A to 15D), once on the target map the feature 25b may be specified to:
Only remain visible for a specified period of time (FIG. 15A),
Convert to another feature state 15c after a specified period of time (FIG. 15B),
Only be visible during specified months of the year (FIG. 150); and
Convert to another feature state 25c during specified months of the year (FIG. 15D).

If none of these behaviours are defined, the feature will not change once it has been transferred to the target map.

The variables required for these behaviours (e.g.: months visible) are either specified during template configuration, or may be specified by a user of the web application in-use (i.e. while collaborating on a particular situation).

More advanced target map behaviour may also be defined such as use polygon as the basis for defining a geofence (a polygon in which the user is notified if specified users, tracked via GPS, move in or out of).

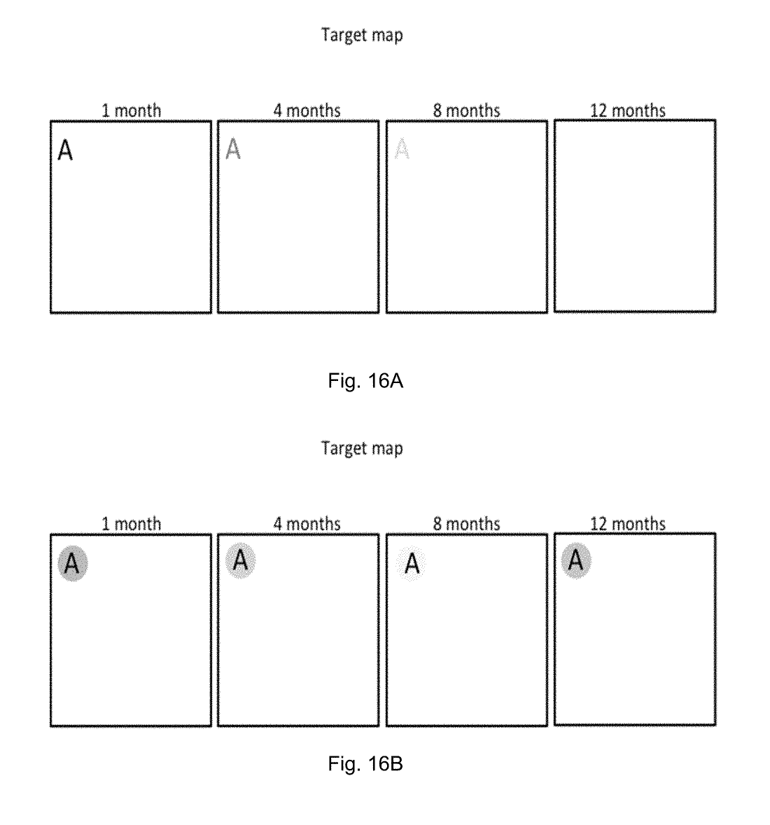

In addition, it may be specified if the feature on the target map be:
Automatically faded the closer it is to its specified time period/months (FIG. 16A); and
Automatically given a different coloured halo (or similar) based on the time since the feature was plotted (FIG. 16B).

In a particular embodiment, the target map behaviour may be backwards compatible with the source map. If configured in such a manner, any change to the feature on the target map will result in a corresponding change to the related feature on the source map.

User Configurable Geospatial Prediction Engine—

For many emergency and field services situations it can be beneficial to predict various spatial related phenomenon for effectively managing the situation.

Examples include:
Managing forest fires: the likely spread and/or flame height of the fire in different parts of the landscape and at different times;
Civil construction: the time it is likely to take to construct a planned new road or power line through a landscape;
Civil maintenance: when a road is likely to require maintenance in different parts of a landscape;
Defence: the likelihood that hostile forces are located in different parts of a landscape;
Forestry: The effect of different management treatments in different parts of the landscape on the yield of forest products;

Generally, such predictions can be grouped into:
Spatial movement of a dependent variable of interest (e.g. a fire edge) across a landscape;
The value of a dependent variable of interest (e.g. flame height) at different locations in the landscape and at different times;
The time it will take for a dependent variable (with or without outside input) to change from one state to another in different parts of the landscape (e.g. a planned road to be constructed); and
The presence/absence or density of a dependent variable of interest across the landscape at different times (e.g. the likelihood of a hostile force location).

Currently, such predictions are generally made by manually using Geographical Information Systems (GIS) to apply mathematical models or logic. Commonly, these models are historic and are based on data collected during specific experiments that had assumptions that may no longer be valid. For example, in Australia the McArthur Forest Fire Danger Model is currently used to predict the rate of spread of bushfires in a wide range of vegetation types. However, this model was developed in the 1960's using data collected from experimental fires in dry eucalypt forests only and accordingly may not be accurate for other species of trees in other scenarios.

Further, such manual methods are often cumbersome and time consuming to implement and generally cannot generate predictions in near real-time. While in some cases, automated systems have been developed to produce such predictions in near real time (e.g. Phoenix to implement the McArthur fire behaviour models), they are still usually based on historical models and logic.

In addition, most predictions are made at a single point in time and are not dynamically and automatically updated when there is a change in intelligence (e.g. the location of a fire edge has moved). This results in predictions that do not reflect the latest intelligence.

In many fields, ‘rules of thumb’ (e.g. the average rate of road construction in flat terrain is 100 m/day) are the main method used to produce predictions. While such an approach can be used to make predictions in near-real time, rules of thumb do not account for the complexities of the landscape and are rarely dynamically adjusted based on on-going experiential data.

In accordance with an embodiment of the present invention, the server 26 implements a user configurable geospatial prediction engine 33 for predicting, in real time, spatial related phenomenon utilising data for a dependent variable received from one or more observation sources (e.g. field users 14, sensors 30, or other suitable observation source). In more detail, the engine 33 is configured to collate the dependent variable data (hereafter “observation data”) with any spatial, non-spatial and/or temporal data (hereafter “independent variable data”) that are determined to be associated with the same location as the observation data. This collated data is stored in the database 28. Responsive to receiving a prediction request, the engine 33 identifies the types and/or values of independent variables for a current state of the phenomenon and uses this to identify the relevant records in the historical database. The engine 33 implements an algorithm that utilises, or is derived from, the retrieved collated data and makes the prediction based on the output of the algorithm. Thus, the engine 22 is user configurable in as much as it can be applied to any spatial phenomena (i.e. anything that can be drawn/plotted on a map) and can be configured to predict whatever it is the user requires based on whatever independent variable data that is available.

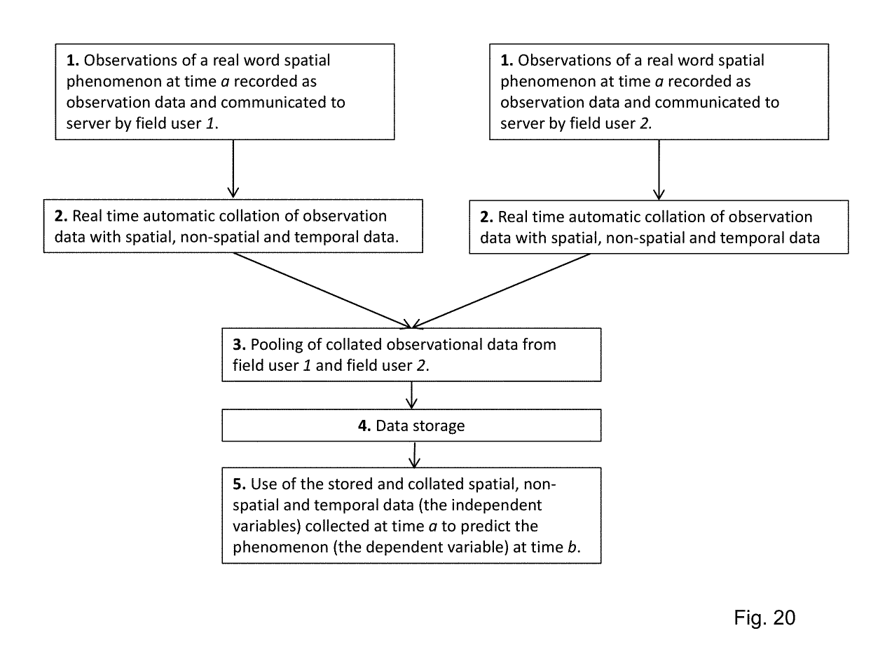

In more detail, and with reference to FIG. 20, there is shown a process flow for predicting a spatial phenomenon based on observation data received from two field users 14.

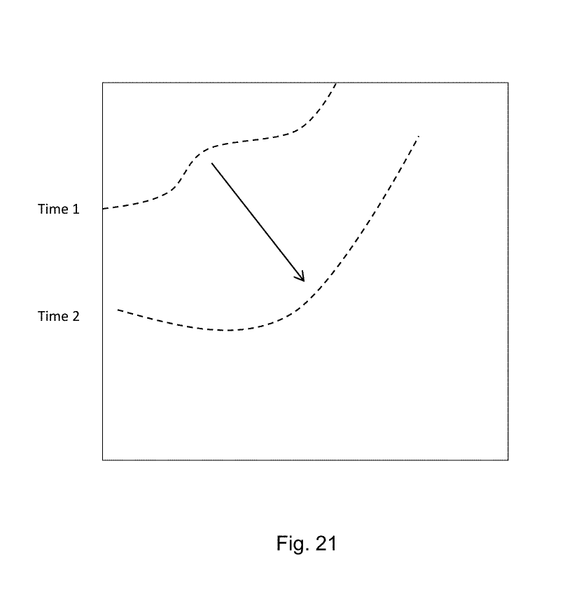

At step S1, the two field users (i.e. field user 1 and field user 2) observe and communicate observation data for one or more dependent variables associated with the spatial related phenomenon to the server 26, via the application 27. The respective observation data is time stamped and referenced with a specific geographical location. By way of example, the spatial phenomenon to be predicted may be the location of a fire edge during a fire suppression operation and the observation data may relate to changes in the current location of the fire edge. FIG. 21 shows an example interface presented via the application to field user 1 allowing them to move a fire edge from a prior location (time 1) to a new/current location (time 2) for the purposes of predicting movement of the fire edge. It will be understood that both the time stamp and geographical reference may be manually entered by the field user using any suitable input means (e.g. drag and drop using a mouse, entry of coordinates using a keypad, etc.), or alternatively automatically entered by the application (e.g. using GPS data for the field user's device 18).

At step 2, responsive to receiving the observation data from the respective field users, the geospatial prediction engine 33 determines whether there are any spatial, non-spatial and/or temporal independent variables associated with the same geographical reference as the observation data. Depending on the desired configuration, the rules implemented by the engine 33 for making the determination may specify that that the independent variables are known to be at the same exact location (i.e. determined from the geographical reference), or within a predefined distance thereof. Further, the rules may require that the independent variables are known to be at the same location (or within a predefined distance thereof) at the same time that observation data was recorded (i.e. determined from the time stamp). For example, the spatial data may comprise a measured fuel load for the geographical location. Independent variable data may be temporal in nature and comprise any independent variable (i.e. a variable whose variation does not depend on that of another) deemed by the engine 33 as relevant to the observation data. The independent variable data may comprise, for example, raw data (e.g. slope and vegetation type), a calculated index (e.g. slope x elevation) or proximity to an independent variable (e.g. 100-200 m from a water course). The spatial, non-spatial and/or independent data may be determined in real or near real time (e.g. from observation or sensor data), or may comprise historical data (e.g. recorded from previous observations, sensor measurements, etc.) if deemed relevant to the current prediction.

In some instances, the independent variable data may be non-spatial in nature. For example, the system may be used to predict whether a ship entering Australia presents a high or low risk from a border security perspective. In making this prediction the independent variables considered by the engine 33 may include the last port the ship has been to (a spatial variable), the time of year (a temporal variable) and the type of cargo the ship is carrying (a non-spatial variable). If ships are then checked and ships importing things they shouldn't recorded in the system, the system collects and pools this data to identify high risk ships in the future based on the last port the ship has been to, the time of year and the type of cargo the ship is carrying.

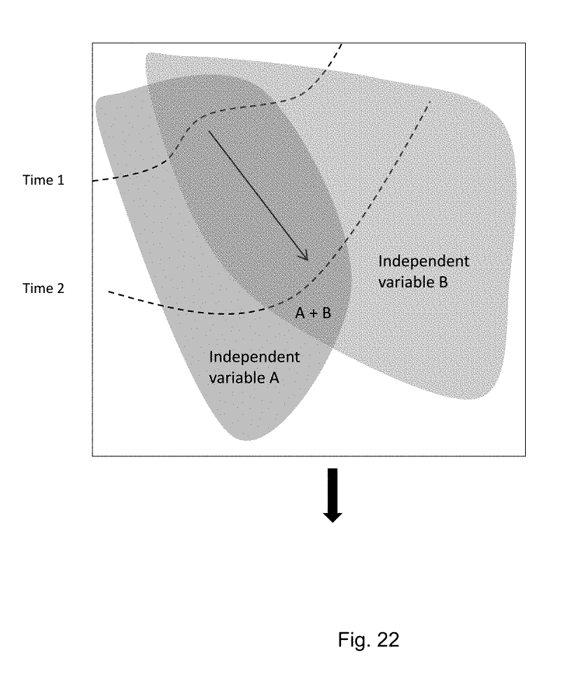

FIG. 22 shows input observation data for the previous example of FIG. 21 (i.e. for predicting movement of a fire edge), overlayed on two independent variables that the engine 33 determines are relevant for collating with the observation data. In this case the independent variables are vegetation types A and B that are located within a predefined area of the observed fire edge at times 1 and 2. Table 1 below shows resultant independent variable data collected by a first field user for the FIG. 22 example.

TABLE 1

| | A | A + B | B |
|---|---|---|---|
| Fire rate of | 1 km/hr | 1.5 km/hr | 1 km/hr |
| movement | | | |

At step 3, the observation data for field user 1 is pooled with the observation data for the field user 2 and subsequently stored (step 4) in the database 28 for use in making future predictions, as afore-described. By way of example, Table 2 below shows example independent variable data collected from a second field user for the FIG. 22 example, while Table 3 shows the collated/processed data for each of the field users evaluated by the engine 33.

TABLE 2

| | A | A + B | B |
|---|---|---|---|
| Fire rate of | .5 km/hr | 2 km/hr | .5 km/hr |
| movement | | | |

TABLE 3

| | A | A + B | B |
|---|---|---|---|
| Fire rate of | 1 km/hr | 1.5 km/hr | 1 km/hr |
| movement | | | |
| Fire rate of | .5 km/hr | 2 km/hr | .5 km/hr |
| movement | | | |

At step 5, the historical data in the database 28 is used to predict the dependent variable (e.g. fire edge) based on the values of the independent variables (spatial, non-spatial and temporal) under the current scenario. The independent variables may be both spatially and temporally variable.

### Types of Prediction

The types of prediction can be generally classified into primary predictions and secondary predictions. The various primary predictions that can be implemented by the engine 33 will now be described.

### Predicting the Movement of a Dependent Variable:

The generic concept is applied to predict the movement of a dependent variable of interest in different spatial locations and at different times.

Dependent variable observational data captured as a feature may be manually moved by users on a map (e.g. the location of a fire edge), or may be a variable with its location automatically moved by GPS tracking (e.g. the location of a vehicle) or by other sensors.

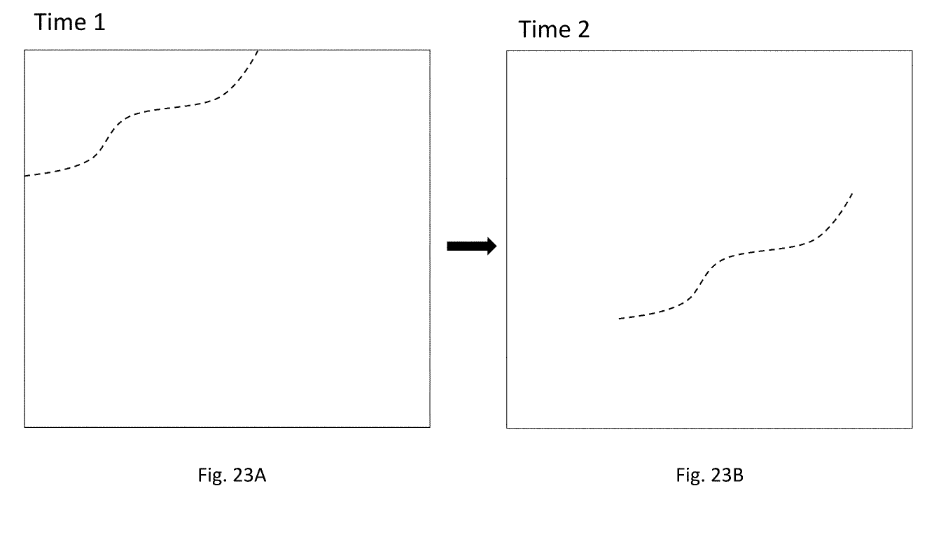

This type of prediction may be used to predict the location of the dependent variable at different times (e.g. could be regular time intervals, for example every hour or a user specified time, for example, at 1600 hrs), or alternatively could be used to estimate the time at which the dependent variable will reach a particular user specified location in the landscape (for example, a road in the case of a bushfire). By way of example, FIG. 23A shows the current location of a fire front at time 1 and FIG. 23B shows the predicted location of the fire front at time 2, as determined by the engine 33.

In one embodiment, different parts of the dependent variable may move at different rates (independent of the combination of independent variables present in different parts of the dependent variable e.g. head fires move more quickly than backfires) and different parts of that variable could be defined and observation data on the rate of movement of each part of the variable collected separately.

### Predicting the Value of a Dependent Variable:

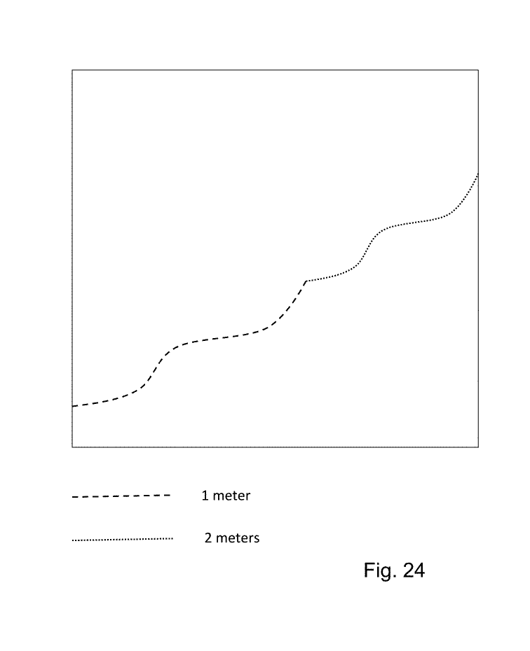

The generic concept is applied to predict the value of a dependent variable of interest across a landscape and at different times. Such a type of prediction is required, for example, to predict the flame height of a bushfire as it spreads across a landscape. An example plot showing predicted flame height over time is shown in FIG. 24.

This type of prediction may be used to predict the value of the dependent variable at different times (could be regular time intervals, for example every hour or a user specified time, for example, at 1600 hrs), or alternatively could be used to identify any time when the dependent variable will exceed or be less than a particular user-specified value. This could be specified for the entire spatial extent of the dependent variable or specific parts of the dependent variable.

### Predicting the Time it Will Take a Dependent Variable to Change State:

The generic concept is applied to predict the time it will take a dependent variable to change from one state to another (for example, a planned new road to change from planned to completed, as shown in FIGS. 25A and 25B respectively). Such a type of prediction is required, for example, to predict how long it will take to complete the construction of a new road.

This type of prediction may be used to estimate the time when the dependent variable will change state or to answer questions of if the dependent variable will have changed state by a user specified time.

### Predicting the Presence/Absence or Density of a Dependent Variable:

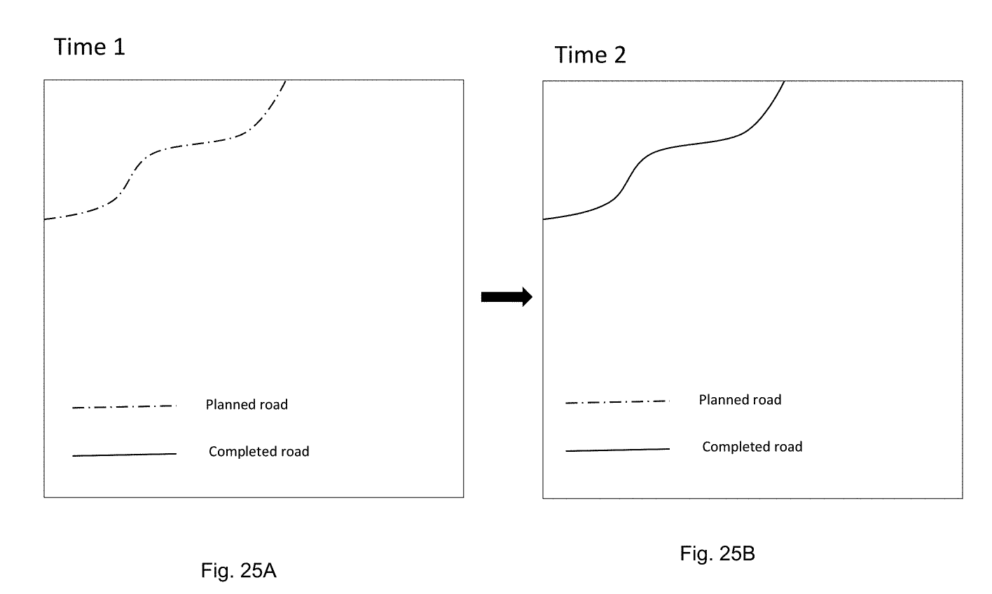

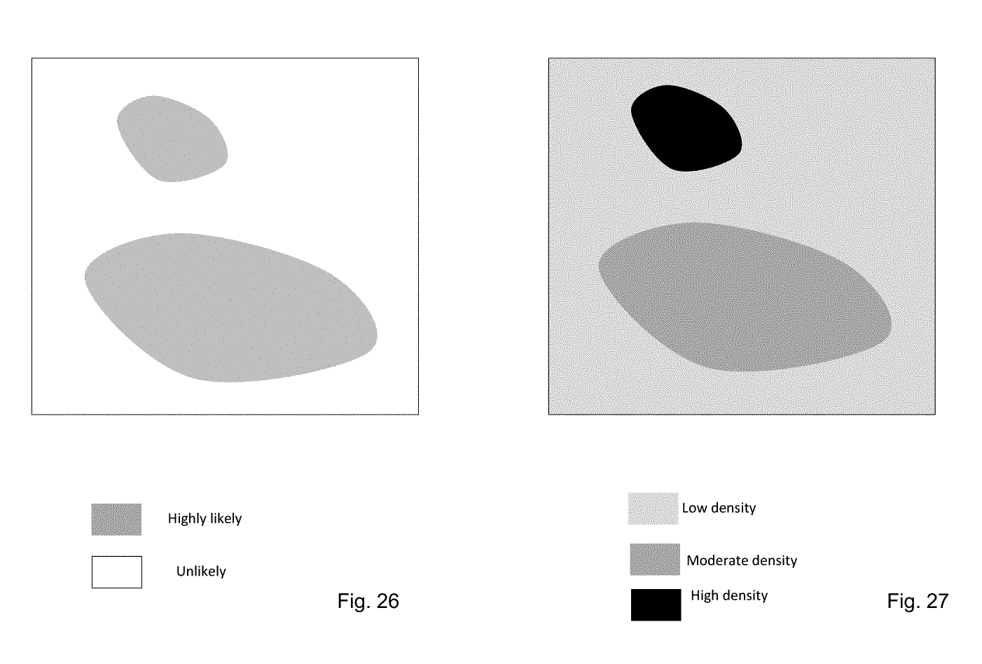

The generic concept is applied to predict the presence/absence (see graph of FIG. 26) or density (FIG. 27) of a dependent variable; for example, the presence/absence of hostile forces in a defence context or the density of a threatened species in a conservation context.

### Secondary Predictions

The primary prediction data may be combined and re-used by the engine 33 to make secondary predictions. Examples include:
Predicting how long it will take to drive between two specified locations at a specified time and therefore what time a person must leave to get to the specified location on time.
Identify the route that will take the shortest time to drive between two specified locations at a specified time.
Predict the impact of a planned activity on various variables (e.g. if a road closure is implemented, what effect will it have on travel time between two specified locations).
Compare predictions of different independent variables. For example, compare a prediction of how long it will take a fire to spread to a particular location with how long it is predicted to complete the construction of a temporary road to contain the fire in that location.
Validation: when a user moves a feature, the engine 33 checks data in database 28 and warns the user if the movement will result in a speed that falls within a high percentile of data stored in the database 28 (e.g. speed will fall within the 99th percentile of data in the database).

### Algorithms

### Extrapolative—

As previously discussed, the engine 33 implements various algorithms to enable predictions to be made beyond the range of independent variable values stored in the database 28, as will now be described in more detail.

### Stored Statistical Relationship Methods

Utilising this form of algorithm, relationships between the dependent and independent variables are automatically and continuously established and re-established using data stored in the database 28. These relationships may be established using techniques such as regression analysis. These relationships are then stored in the database 28 in the form of equations.

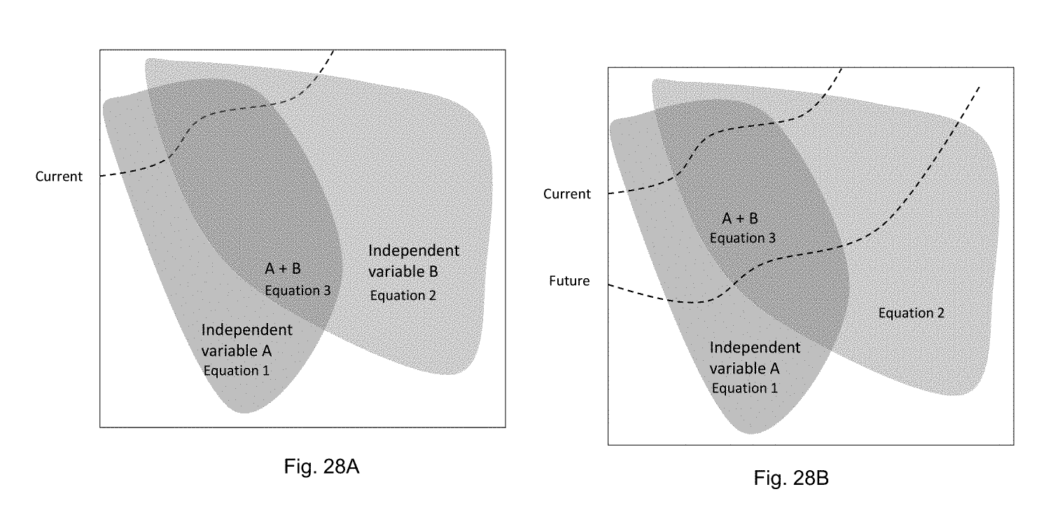

When a user requests that a prediction be made, the spatial prediction engine 33 identifies the combination of independent variables stored in the database 28 and their values under the current scenario and, based on this, applies the appropriate equations to predict the dependent variable. An example procedure for such a prediction is schematically illustrated in FIGS. 28A and 28B.

In a first step, the engine 33 retrieves the relevant historical data from the database 28. In this instance, the spatial phenomenon to be predicted is the location of a fire front at a future time. By way of example, the engine 33 may determine that the relevant historical data is the rate of movement of a fire front for the mapped independent variables, as per Table 4 below.

TABLE 4

| | A | A + B | B |
|---|---|---|---|
| Fire rate of | 1 km/hr | 1.5 km/hr | 1 km/hr |
| movement | | | |
| Fire rate of | .5 km/hr | 2 km/hr | .5 km/hr |
| movement | | | |

The engine 33 then establishes relationships between the dependent and independent variables using the data in the database 28. By way of example, the following equations may be determined by the engine 33 that represent the relationships:

Rate of spread=1.23+3.4a Equation 1:

Rate of spread=6.76+34.1b Equation 2:

Rate of spread=8.93+5.6a+45.7bu Equation 3:

Based on the independent variables present, the appropriate equations to apply are identified in the database 28. The equations are then applied to predict the future location of the dependent variable. FIG. 28A shows the independent variables under the current scenario, while FIG. 28B shows the predicted dependent variable at a future time.

As the equations used to make predictions may be established and stored in advance of when a prediction is requested, this approach enables these equations to be transferred to mobile devices 18 where they can be stored either via the application 27, or the application cache of the browser (and then applied to make predictions even when the device is off-line).

This algorithm results in a single prediction (e.g. line) rather than a zone of prediction.

### On the Fly Statistical Relationship Methods

Utilising this form of algorithm, relationships are not established and stored in the database 28 in advance. Rather, when a user requests that a prediction be made, the engine 33 identifies the combination of independent variables present under the current scenario that meet the predefined criteria for that prediction. The engine 33 then queries the database 28 to identify data relating to the dependent and independent variables and uses this data to establish a relationship between the dependent and independent variables (e.g.: using regression analysis) which is then applied using the values of the independent variables under the current scenario to predict the dependent variable. An example procedure for such a prediction is schematically illustrated in FIGS. 29A and 29B.

In a first step, a user accesses the application 27 and requests a particular prediction to be made. The engine 33 identifies the range of independent variables present (in this case A and B) for the requested location (see FIG. 29A). The engine 33 then retrieves the relevant historical data from the database 28. In this instance, the spatial phenomenon to be predicted is the location of a fire front at a future time. The engine 33 may determine that the relevant historical data is the rate of movement of a fire front for the mapped independent variables, as per Table 5 below.

TABLE 5

| | A | A + B | B |
|---|---|---|---|
| Fire rate of | 1 km/hr | 1.5 km/hr | 1 km/hr |
| movement | | | |
| Fire rate of | .5 km/hr | 2 km/hr | .5 km/hr |
| movement | | | |

The engine 33 then establishes relationships between the dependent and independent variables using the data in the database 28. By way of example, the following equations may be determined by the engine 33 that represent the relationships:

Rate of spread=1.23+3.4a Equation 1:

Rate of spread=6.76+34.1b Equation 2:

Rate of spread=8.93+5.6a+45.7bu Equation 3:

FIG. 29B shows the value of the dependent variable at a future time. As shown, this algorithm results in a single prediction (e.g. line) rather than a zone of prediction.

### Non-Extrapolative Algorithms

These algorithms only enable predictions to be made within the range of independent variable values stored in the historical database.

### All Relevant Data Methods

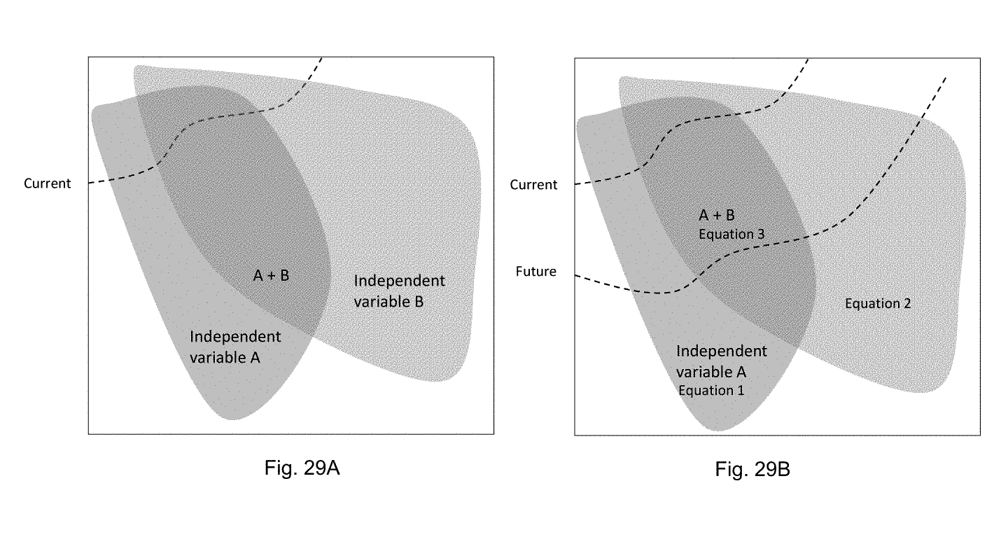

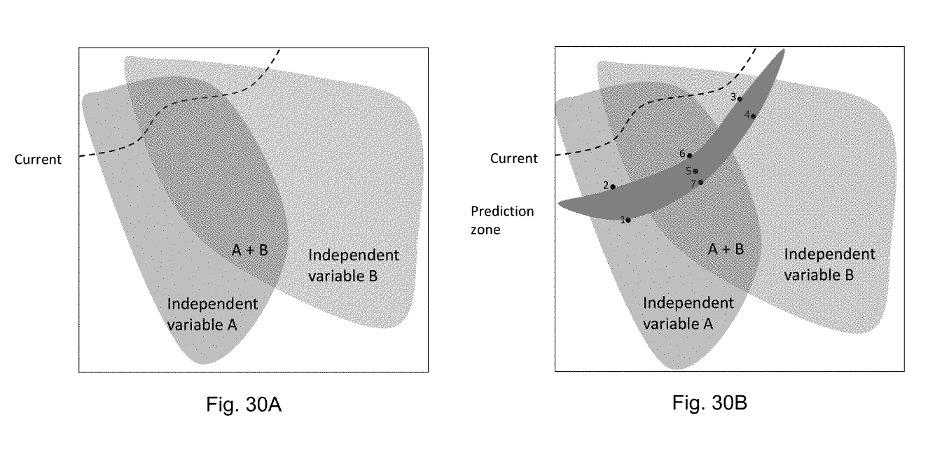

Utilising this form of algorithm, all existing data in the database 28 that matches the same combination of values of the independent variables as under the current scenario is identified by query. The recorded values of the dependent variable under all these past cases is then used directly (as opposed to being used to establish a statistical relationship) to make the prediction. This may result in several individual predictions per combination of independent variables and therefore will result in a zone of prediction (with differing densities) rather than a single prediction. An example procedure for such a prediction is schematically illustrated in FIGS. 30A and 30B.

As for the previous examples, a user requests a prediction be made using the application 27. The engine 33 identifies the independent variables present, as schematically illustrated in FIG. 30A. The engine 33 then queries the database 28 to identify all of the data therein that contains the independent variables. An example of the resultant data in table form is shown below in Table 6.

TABLE 6

| | Independent | Fire rate of |
|---|---|---|
| ID | Variables | movement (km/h) |
| 1 | A | 1 |
| 2 | A | 0.5 |
| 3 | B | 0.25 |
| 4 | B | 0.5 |
| 5 | A + B | 1 |
| 6 | A + B | 0.75 |
| 7 | A + B | 1.25 |

The engine 33 then plots the dependent variable from all of these cases creating a zone of prediction, as schematically illustrated in FIG. 30B.

### Averaging Methods

Utilising this form of algorithm, all existing data in the database 28 that matches the same combination of values of the independent variables as the current scenario is automatically identified by query. The recorded values of the dependent variable under all these past cases is averaged. This averaged value is then applied to the current scenario to make a prediction. An example procedure for such a prediction is schematically illustrated in FIGS. 31A and 31B.

As for the previous examples, a user requests a prediction be made using the application 27. The engine 33 identifies the independent variables present, as schematically illustrated in FIG. 31A. The engine 33 then queries the database 28 to identify all of the data therein that contains the independent variables. An example of the resultant data in table form is shown below in Table 7.

TABLE 7

| | Independent | Fire rate of |
|---|---|---|
| ID | Variables | movement (km/h) |
| 1 | A | 1 |
| 2 | A | 0.5 |
| 3 | B | 0.25 |
| 4 | B | 0.5 |
| 5 | A + B | 1 |
| 6 | A + B | 0.75 |
| 7 | A + B | 1.25 |

The engine 33 then identifies the average value of the dependent variable for each combination of independent variables, as shown in Table 7 below.

TABLE 8

| Independent | Fire rate of |
|---|---|
| Variables | movement (km/h) |
| A | .75 |
| B | 0.375 |
| A + B | 1.0 |

The engine 33 then plots the averages to create a prediction, as schematically illustrated in FIG. 31B.

While this algorithm results in a single prediction (e.g. line), calculated standard deviations may be used to create confidence zones around this single prediction.

### Number of Same Historical Cases Methods

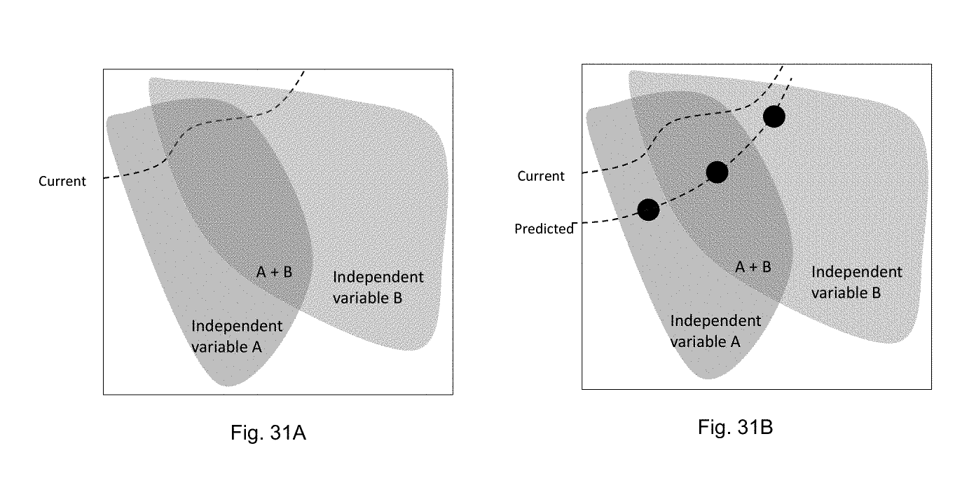

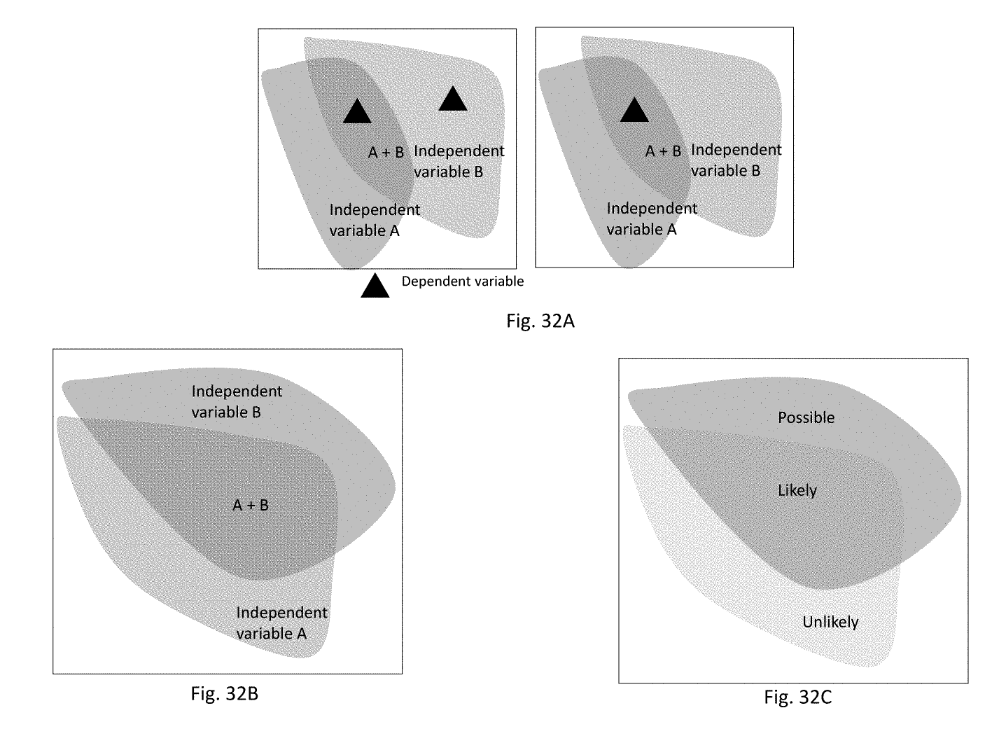

Utilising this form of algorithm, all existing data in the database 28 that matches the same combination of values of independent variables as under the current scenario is automatically identified by query. The frequency the dependent variable was recorded as being present in these historical cases is used to predict the likelihood of the presence/absence of the dependent variable in the current scenario. An example procedure for such a prediction is illustrated in FIGS. 32A, 32B and 32C.

As for the previous examples, a user requests a prediction be made using the application 27. The engine 33 identifies the independent variables present and queries the database 28 to identify all of the data therein that contains the independent variables. An example of the resultant data in table form is shown below in Table 9, and schematically illustrated in FIG. 32A (where the left graphic illustrates a first historical case and the right graphic illustrates a second historical case).

TABLE 9

| | Present of |
|---|---|
| Independent | dependent |
| Variables | variable |
| A | 0 |
| B | 1 |
| A + B | 2 |

The engine 33 then determines a distribution of the independent variables in the current scenario, as illustrated in FIG. 32B. Finally, the historic data is applied to predict the presence/absence of the dependent variable in the current scenario (see FIG. 32C). In this instance, the engine ranks the resultant data to determine the likelihood (although it will be understood that any suitable ranking or probability allocation could be utilised, depending on the desired implementation).

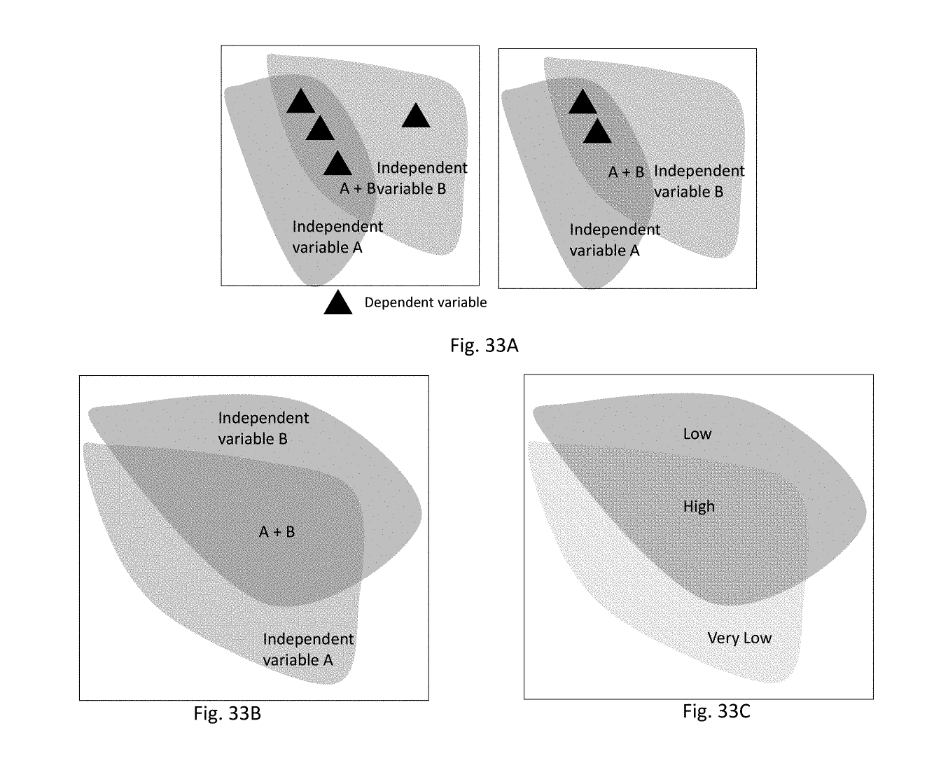

The same general algorithm can be used to predict the density of the dependent variable in the current scenario based on the recorded densities of the dependent variable in the same combinations of independent variables in historical data. An example procedure for such a prediction is schematically illustrated in FIGS. 33A, 33B and 33C.

As for the previous examples, a user requests a prediction be made using the application 27. The engine 33 identifies the independent variables present and queries the database 28 to identify all of the data therein that contains the independent variables. An example of the resultant data in table form is shown below in Table 10, and schematically illustrated in FIG. 33A (where the left graphic shows a first historical case and the right graphic shows a second historical case).

TABLE 10

| | Count of |
|---|---|
| Independent | dependent |
| Variables | variable |
| A | 0 |
| B | 1 |
| A + B | 5 |

The engine 33 then determines a distribution of the independent variables in the current scenario, as illustrated in FIG. 33B. Finally, the historic data is applied to predict the density of the dependent variable in the current scenario (see FIG. 33C). In this instance, the engine utilises a sliding scale to determine a density measure (although it will be understood that any suitable ranking or classification could be utilised, depending on the desired implementation).

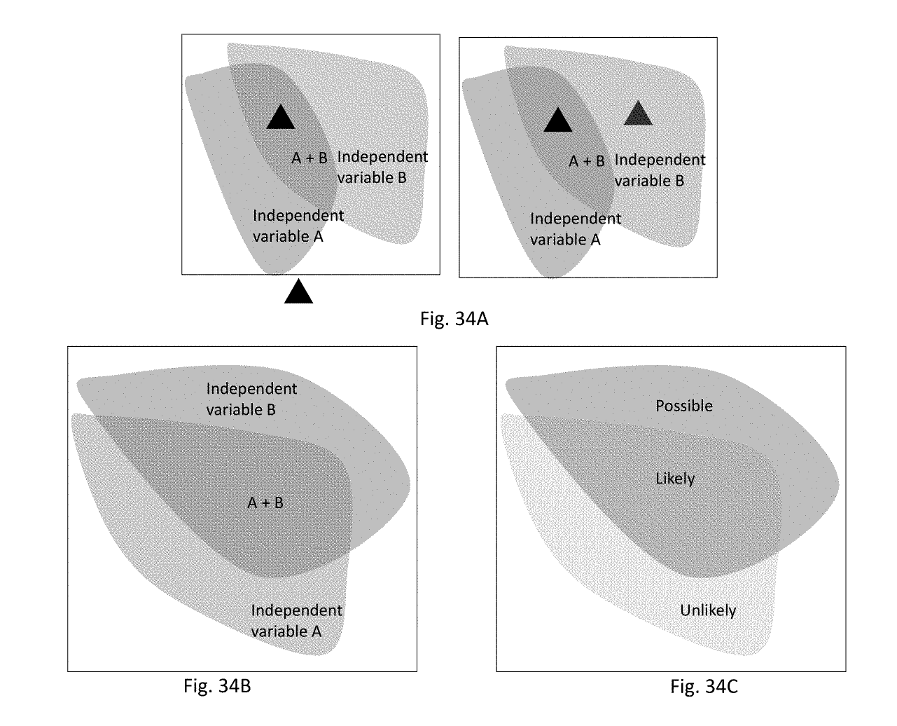

The length of time the dependent variable was present or length of time by density of the dependent variable in historic data can also be used in the prediction of the presence/absence and density of the dependent variable under the current scenario. An example procedure for such a prediction is schematically illustrated in FIGS. 34A, 34B and 34C.

As for the previous examples, a user requests a prediction be made using the application 27. The engine 33 identifies the independent variables present and queries the database 28 to identify data therein that contains the independent variables at different times. An example of the resultant data in table form is shown below in Table 11, and schematically illustrated in FIG. 34A (where the left graphic shows historical data for time 1 and the right graphic shows historical data for time 2).

TABLE 11

| | Time dependent |
|---|---|
| Independent | variable present |
| Variables | (hrs) variable |
| A | 0 |
| B | 1 |
| A + B | 2 |

The engine 33 then determines a distribution of the independent variables in the current scenario, as illustrated in FIG. 34B. Finally, the historic data is applied to predict the presence or absence of the dependent variable in the current scenario (see FIG. 34C). In this instance, the engine utilises a sliding scale to predict the presence or absence of the dependent variable in the current scenario (although it will be understood that any suitable ranking or classification could be utilised, depending on the desired implementation).

Incorporating Feedback from the Current Scenario

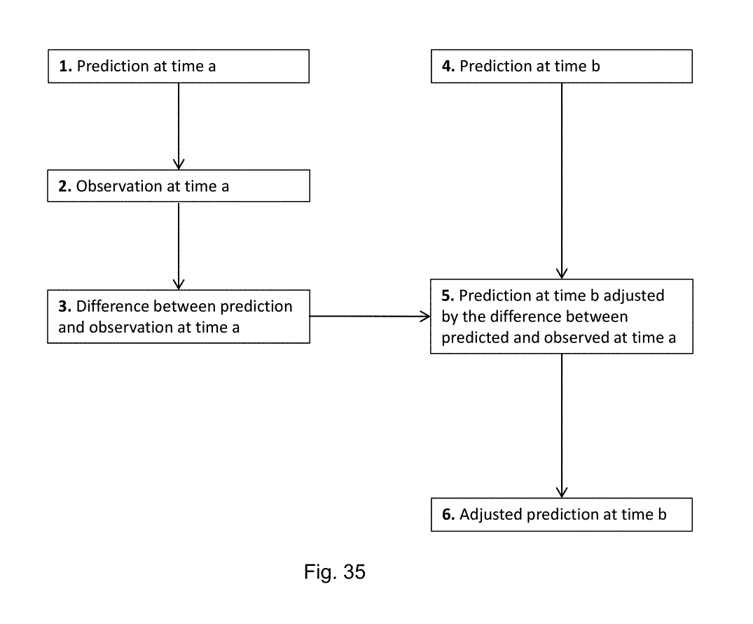

The predictions made based on historic data may be continuously adjusted based on observation data (i.e. for the dependent variable) received from the field users 14. This is pictorially represented in FIG. 35.

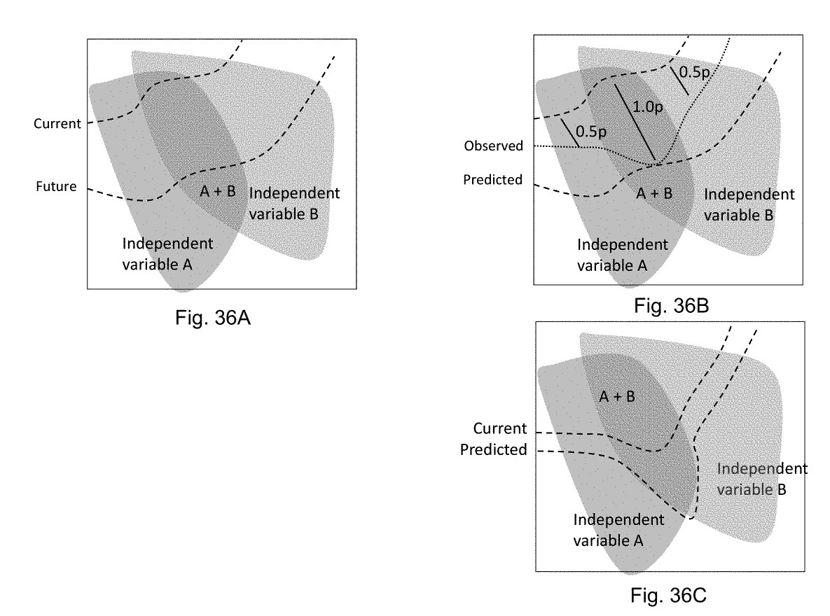

A range of algorithms may be used to correct predictions made at time b in the current scenario based on observations of the dependent variable at time a in the current scenario, as shown in FIGS. 36A, 36B and 36C. In this case, FIG. 36A shows predicted movement of a feature at time a. FIG. 36B shows observed movement of a feature at time a as a proportion of predicted movement. Table 12 below shows example historical data retrieved by the engine 33 for making a prediction at time b, while Table 13 shows observational data from time a used to correct the prediction for time b. FIG. 36C shows the prediction for time b based on observations from time a. As time progresses and further predictions and observations are made, the average of the difference between predictions and observed (e.g. the average of the difference between observed and predicted at times a, b and c applied to correct the prediction made based on historic data at time d) may be applied resulting in predictions in the current scenario improving as schematically illustrated in FIGS. 37A and 37B. In this example, FIG. 37A shows uncorrected predicted movement of a feature at time d. The engine 33 retrieves observation data from an earlier time (stored in the database 28) to correct the prediction for time d as shown in FIG. 37B. Table 12 below shows example observation data for correcting the prediction.

TABLE 12

| | A | A + B | B |
|---|---|---|---|
| Uncorrected predicted | 1.0 km/h | 1.5 km/h | 1 km/h |
| rate of movement at | | | |
| time d | | | |
| Correction from time a | 0.25 km/h | 1.0 km/h | 0.5 km/h |
| observations | | | |
| Correction from time b | 0.25 km/h | 1.0 km/h | 0.5 km/h |
| observations | | | |
| Correction from time c | 0.25 km/h | 1.5 km/h | 0.5 km/h |
| observations | | | |
| Correction from time a, | 0.25 km/h | 1.5 km/h | 0.5 km/h |
| b, c observations | | | |
| Corrected predicted | 0.25 km/h | 2.25 km/h | 0.5 km/h |
| rate of movement at | | | |
| time d | | | |

### Automatic Dynamic Predictions

The system may monitor for changes in dependent variables in the current scenario (e.g. a new location for a fire edge is plotted) and when a change is detected, the relevant prediction algorithm automatically re-run resulting in predictions automatically being re-run in response to changes in dependent variables.

### Prediction Modes

### Two Dimensional

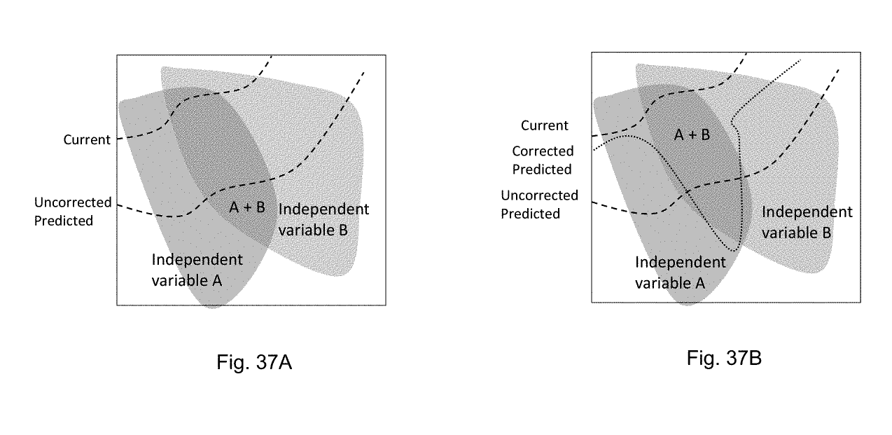

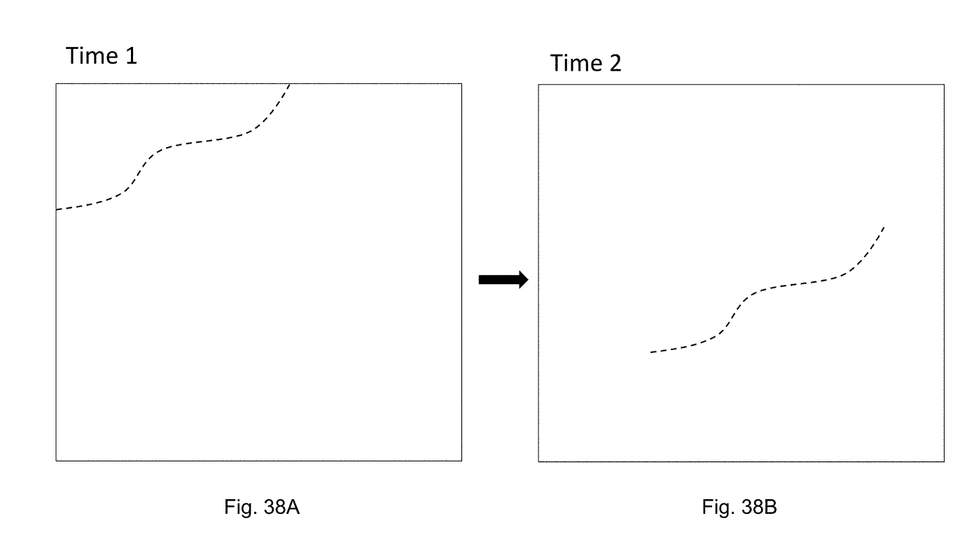

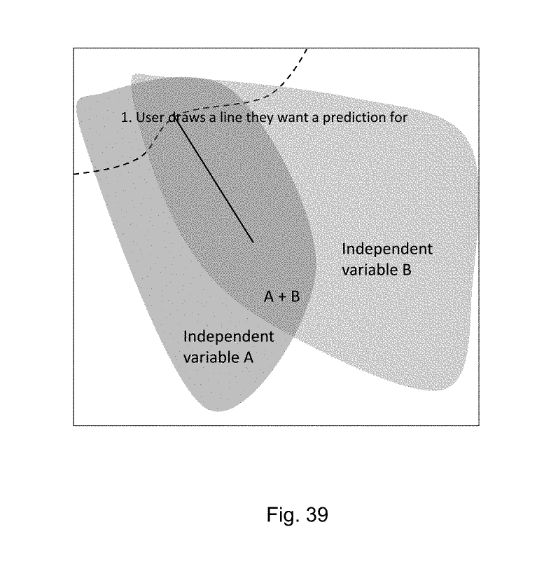

The two-dimensional approach may be used to make predictions across a 2 dimensional surface and the results of the prediction presented as a map, as shown in FIG. 38A (showing time 1) and FIG. 39B (showing time 2).

### One Dimensional

The one-dimensional approach may be used to make predictions along a line drawn by the user specifically for the purpose of making a prediction, or along an existing line such as a road. Results may be presented in the form of statistical information (e.g. the number of minutes it is estimated for a fire to spread the length of the line), or this statistical information used to make secondary predictions as afore-described.

By way of example, FIG. 39 shows a user drawn line they want a prediction for. Table 13 below shows historical data that the engine 33 may retrieve for independent variables that the line traverses (identified by a query for all independent variable associated with the relevant map co-ordinates).

TABLE 13

| | A | A + B | B |
|---|---|---|---|
| Fire rate of | 1 km/hr | 1.5 km/hr | 1 km/hr |
| movement | | | |

Finally, using the historical data and the length of the drawn line, the engine 33 predicts the time it will take a fire to travel the length of the line as follows:

Travel time=2 km×1.5 km/hr

Travel time=3 hrs

### Dynamic Versus Static

The approach may be applied to predict dependent variables when the independent variables are static in time (e.g. slope, soil type) or where the independent variables change dynamically with time (e.g.: wind speed, temperature). Thus, the predictions of the dependent variable may be static or dynamic in time.

### Hierarchical

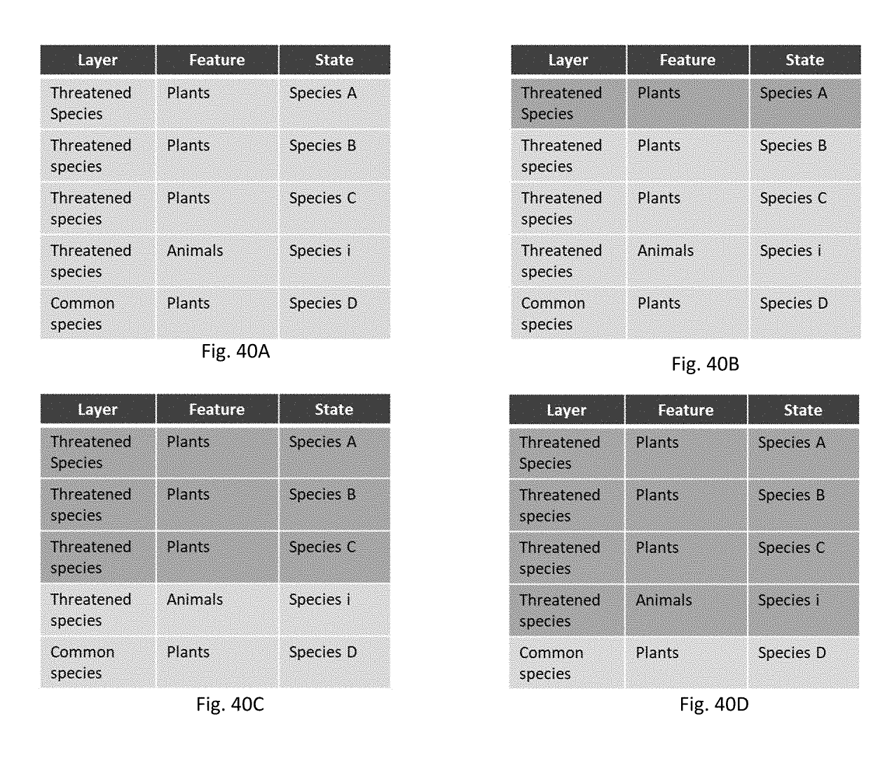

If the dependent variable is part of a hierarchical structure (e.g. the dependent variable is a particular state of a map feature which belongs to a map layer), predictions may be made at any level in the hierarchy (that is to predict the particular feature state, any feature state belonging to the feature or any feature belonging to that layer). As the user specifies a higher level in the hierarchy, the pool of historical data used to make the prediction is increased. This will result in more historical data being used to make predictions at higher hierarchical levels. FIG. 40A shows example historic data of flora and fauna observations stored with a layer—feature—state hierarchical structure. FIG. 40B shows example data that will be used to predict density at the state level (specific species—species A). FIG. 40C shows example data that will be used to predict density at the feature level (any threatened plant of any species). FIG. 40D shows example data that will be used to predict density at the layer level (any threatened flora or fauna).

### Options Analysis

The approach may be applied to predict the dependent variable under a range of alternative courses of action. Generating each alternative involves drawing different independent variables of different values on a map. The combination of existing and alternative scenario independent variable values are then used as the basis for predicting the dependent variable of interest. The value of the dependent variable under the different alternatives can then be compared in a table.

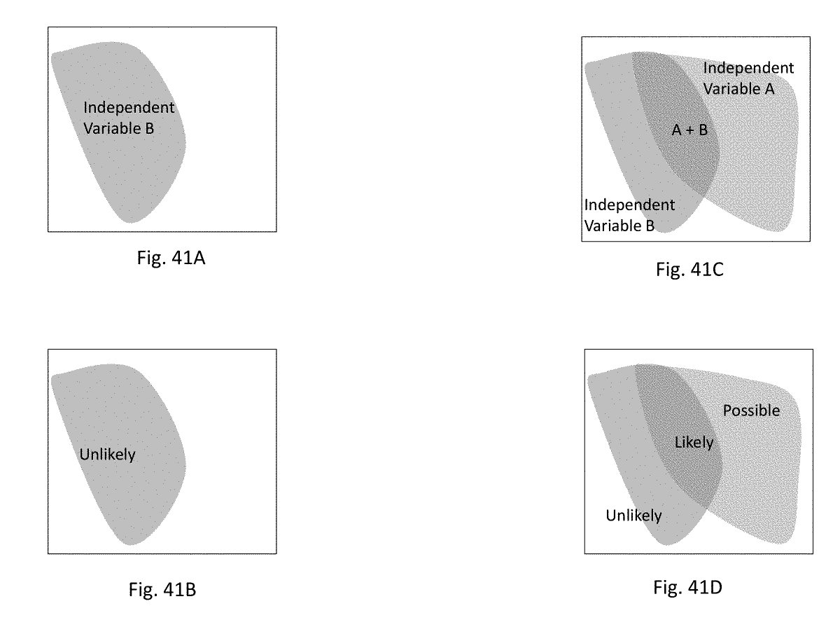

By way of example, FIG. 41A shows a range of existing independent variable present for a location.

Table 14 below shows historical data used to make the prediction of presence/absence retrieved by the engine 33.

TABLE 14

| | Presence of |
|---|---|
| Independent | dependent |
| Variables | variable |
| A | 0 |
| B | 1 |
| A + B | 2 |

FIG. 41B shows the resulting prediction of likelihood of presence/absence of the dependent variable, while FIG. 41C shows a new map drawn by a user with features representing an alternative course of action. The engine 33 then retrieves historical data for making a prediction of presence/absence under alternative course of action (in this case resulting in the same data as shown in Table 14). Finally, FIG. 41D schematically illustrates the resultant prediction of likelihood of presence/absence of the dependent variable under the alternative course of action.

### Maximum and Minimum

The approach may be applied to identify, given the existing combination of independent variable values, the combination of additional independent variable values that will result in either the maximum or minimum value of the dependent variable. This could be used, for example, to predict what additional treatments (e.g. fertilizing) will result in maximum wood volume production in a forest given the existing soil fertility. The contribution each independent variable makes to maximising or minimising the dependent variable could be derived.

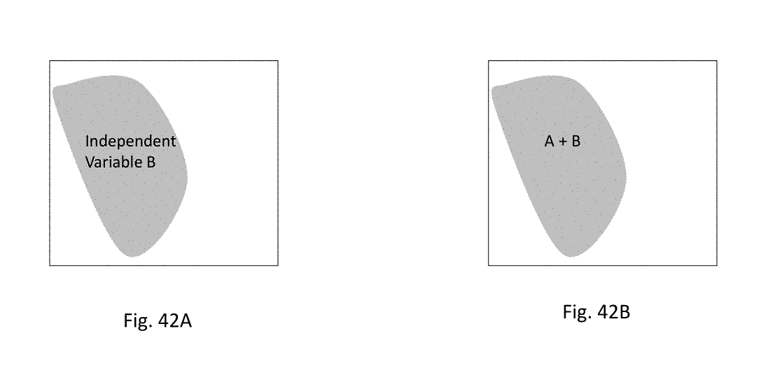

By way of example, FIG. 42A shows a range of existing independent variable present for a location. Table 16 below shows historical data used to make the prediction of presence/absence retrieved by the engine 33, highlighting the combination of independent variables that will maximize the value of the dependent variable.

TABLE 15

| | Presence of |
|---|---|
| Independent | dependent |
| Variables | variable |
| A | 0 |
| B | 1 |
| A + B | 2 |

Using the historical data, the combination of independent variables that will maximize the dependent variable is determined (see schematic of FIG. 41B).

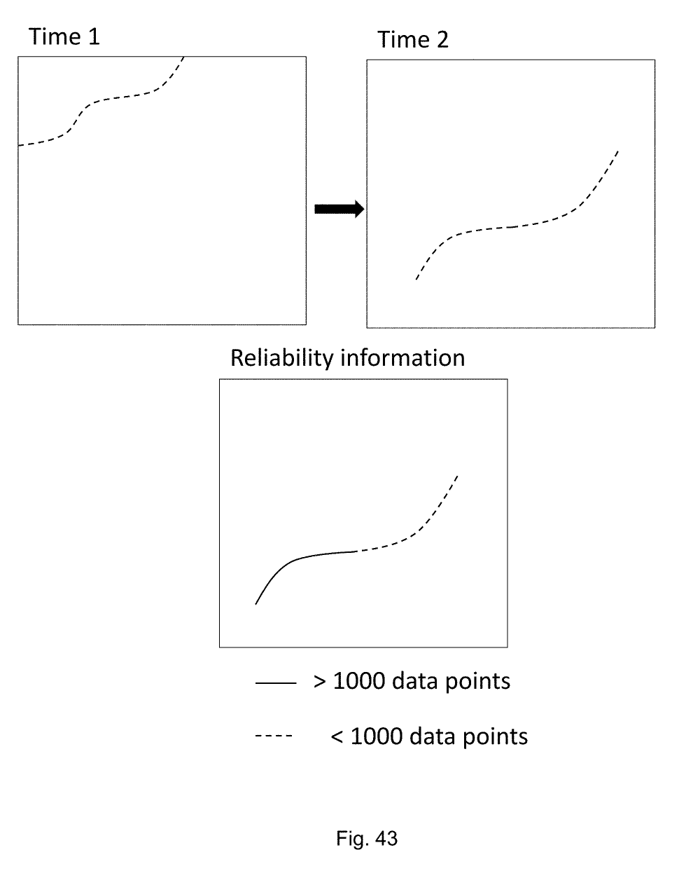

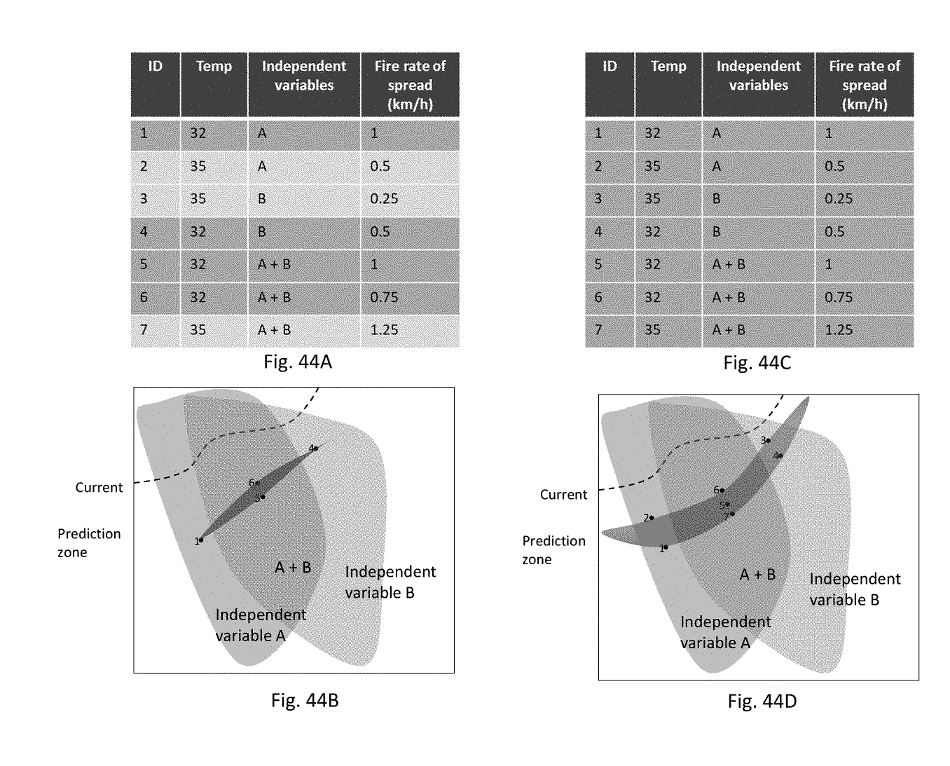

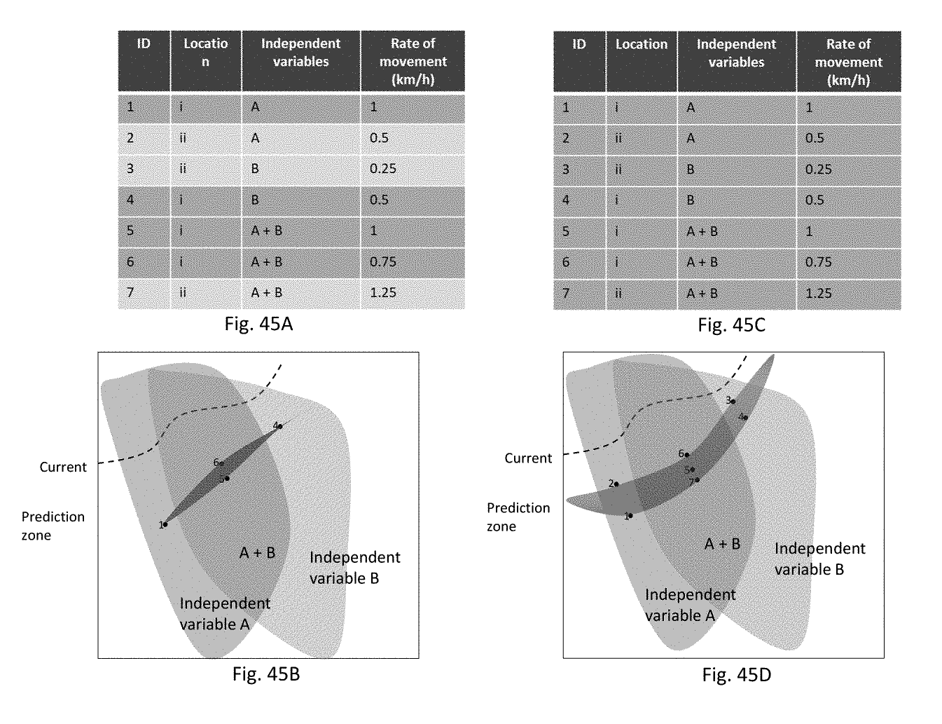

The advantages of a big data driven artificial intelligence approach to spatial prediction include:
Predictions are not based on historical models but are based on real world data.
Predictions incorporate on-going and recent experiential data.
Predictions can be made even if there has not been research into the phenomena.
Reduces errors because predictions are made directly based on the independent variable data rather than independent variables being used to predict an intermediate dependent variable which then becomes an independent variable input for predicting the final dependent variable.
Predictions can be made in real time.
The prediction process can be automated such that predictions can be made by those without high level skills/knowledge of the dependent variable.
Information can be provided on the reliability of the prediction at the time of prediction by providing the user with information on the number of historical records the prediction is based on (e.g. the database contains only a single historical record with the same combination of independent variables as the current scenario, or the database contains 10000 records with the same combination of independent variables as the current scenario, as schematically shown in FIG. 43). Information on the reliability of the prediction can be provided at the same time as the prediction in the form of a colour coded map. Some prediction algorithms will also enable the calculation of other statistics on the reliability of predictions (e.g. r2 values if regression techniques are used).
Sensitivity analysis can be easily undertaken and incorporated into predictions in real time which results in data points with a wider range of values than is actually present under the current scenario being selected from the historical database and being used as the basis for making predictions. By way of example, FIG. 44A shows a table listing Historical data used when user requests a prediction with temperature=32. FIG. 44B is a schematic representation of the prediction. FIG. 44C shows a table listing historical data retrieved and used by the engine 33 when a user requests prediction with temperature=32 to 40. FIG. 44D is a schematic representation of the prediction.
If the user believes the current location/event is ‘different’ to other locations/events from which historical data was collected, the user can specify that the data on which predictions are based be limited to previous data collected from the current location/event. If the user believes the prediction has not accounted for a site specific issue they may manually adjust the prediction by moving the prediction line or boundaries of the prediction polygon. By way of example, FIG. 45A shows a table listing historical data retrieved and used by the engine 33 when user requests a prediction limiting the data used for the prediction to that collected at location i. FIG. 45B is a schematic representation of the prediction. FIG. 45C shows a table listing historical data retrieved and used by the engine 33 when a user allows the data to for prediction to be from location i to ii. FIG. 45D is a schematic representation of the prediction.

### Further Detail of System Configuration

The web server 26 can be any form of suitable server computer that is capable of communicating with user computing devices 18 via a suitable network. The server 26 may include typical web server hardware including a processor, motherboard, memory, hard disk and a power supply. The server 26 includes an operating system which co-operates with the hardware to provide an environment in which software applications can be executed. In this regard, the hard disk of the server 26 is loaded with a processing module which, under the control of the processor, is operable to implement the web application 27 for carrying out the aforementioned functions. In an alternative embodiment, the computer platform may be implemented as a cloud based application (i.e. in a secure web based cloud environment), using techniques which will be well understood by persons skilled in the art.

The various aspects discussed herein may be implemented via any appropriate number and/or type of computer platform, modules, processors, memory, etc. each of which may be embodied in hardware, software, firmware, middleware and the like. Persons skilled in the art will appreciate that in accordance with known techniques, functionality at the server side of the network may be distributed over a plurality of different computers. For example, elements may be run as a single “engine” on one server, or a separate server may be provided.

While the invention has been described with reference to the present embodiment, it will be understood by those skilled in the art that alterations, changes and improvements may be made and equivalents may be substituted for the elements thereof and steps thereof without departing from the scope of the invention. In addition, many modifications may be made to adapt the invention to a particular situation or material to the teachings of the invention without departing from the central scope thereof. Such alterations, changes, modifications and improvements, though not expressly described above, are nevertheless intended and implied to be within the scope and spirit of the invention. Therefore, it is intended that the invention not be limited to the particular embodiment described herein and will include all embodiments falling within the scope of the independent claims.

As indicated above, the method is implemented by way of an application comprising program code. The application/program code could be supplied in a number of ways, for example on a tangible computer readable storage medium, such as a disc or a memory device, e.g. an EEPROM, (for example, that could replace part of memory 103) or as a data signal (for example, by transmitting it from a server). Further, different parts of the program code can be executed by different devices, for example in a client server relationship. Persons skilled in the art, will appreciate that program code provides a series of instructions executable by the processor.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

The claims defining the invention are as follows:

1. A method for predicting a spatial location of a real-world phenomenon at a future time, the method comprising:
(a) receiving dependent variable data for one or more dependent variables associated with the phenomenon from an observation source, the dependent variable data being time stamped and including a geographical reference;
(b) responsive to receiving the dependent variable data, collating the dependent variable data with independent variable data for one or more independent variables associated with the geographical reference and storing the collated data in a data store;
(c) receiving a prediction request for predicting the spatial location of the real-world phenomenon at the future time;
(d) retrieving collated data that satisfy a predefined relevance criterion; and
(e) implementing an algorithm that utilises or is derived from the retrieved collated data and predicting the spatial location of the real-world phenomenon based on the output of the algorithm.

2. A method in accordance with claim 1, wherein the predefined relevance criterion is that the collated data comprises independent variable data associated with a current state of the real-world phenomenon.

3. A method in accordance with claim 2, wherein the predefined relevance criterion is that the collated data comprises one or more of the same independent variables determined to be present at, or located within a predefined distance of, the current location of the real-world phenomenon.

4. A method in accordance with claim 2, wherein the algorithm utilises or is additionally derived from a value and/or type of the independent variables at the current location of the real-world phenomenon.

5. A method in accordance with claim 2, further comprising evaluating one or more independent variables associated with the predicted spatial location and updating the prediction based thereon.

6. A method in accordance with claim 5, wherein the step of updating the prediction comprises re-implementing the algorithm utilising collated data associated with the one or more independent variables for the predicted spatial location.

7. A method in accordance with claim 1, further comprising receiving real time dependent variable data from an observation source for a current state of the real-world phenomenon and updating the prediction based on the real time dependent variable data.

8. A method in accordance with claim 1, further comprising repeating steps (a) and (b) for additional dependent variable data for the real-world phenomenon received from the or another observation source.

9. A method in accordance with claim 8, further comprising (f) processing the stored collated data to determine relationships between the geographically associated dependent and independent variables and wherein the implemented algorithm is derived from the relationships.

10. A method in accordance with claim 9, wherein step (f) is implemented each time additional dependent variable data is received from the or another observation source.

11. A method in accordance with claim 1, wherein the independent variables comprise at least one of a spatial, non-spatial and temporal independent variable type determined to be at, or within a predefined proximity of, the geographical reference.

12. A method for predicting a time at which a real-world phenomenon will arrive at a predefined spatial location, the method comprising:
(a) receiving dependent variable data for one or more dependent variables associated with the phenomenon from an observation source, the dependent variable data being time stamped and including a geographical reference;
(b) responsive to receiving the dependent variable data, collating the dependent variable data with independent variable data for one or more independent variables associated with the geographical reference and storing the collated data in a data store;
(c) receiving a prediction request for predicting the time at which the real-world phenomenon will arrive at the predefined spatial location;
(d) retrieving collated data that satisfy a predefined relevance criterion; and
(e) implementing an algorithm that utilises or is derived from the retrieved collated data and predicting the time based on the output of the algorithm.

13. A method in accordance with claim 12, wherein the predefined relevance criterion is that the collated data comprises independent variable data associated with a current state of the real-world phenomenon.

14. A method in accordance with claim 13, wherein the predefined relevance criterion is that the collated data comprises one or more of the same independent variables determined to be present at, or located within a predefined distance of, the current location of the real-world phenomenon.

15. A method in accordance with claim 13, wherein the algorithm utilises or is additionally derived from a value and/or type of the independent variables at the current and/or predefined spatial location of the real-world phenomenon.

16. A method in accordance with claim 13, further comprising evaluating one or more independent variables associated with the predicted time and updating the prediction based thereon.

17. A method in accordance with claim 16, wherein the step of updating the prediction comprises re-implementing the algorithm utilising collated data associated with the one or more independent variables for the predicted time.

18. A method in accordance with claim 12, further comprising receiving real time dependent variable data from an observation source for a current state of the real-world phenomenon and updating the prediction based on the real time dependent variable data.

19. A method in accordance with claim 12, further comprising repeating steps (a) and (b) for additional dependent variable data for the real-world phenomenon received from the or another observation source.

20. A method in accordance with claim 19, further comprising (f) processing the stored collated data to determine relationships between the geographically associated dependent and independent variables and wherein the implemented algorithm is derived from the relationships.

21. A method in accordance with claim 20, wherein step (f) is implemented each time additional dependent variable data is received from the or another observation source.

22. A method in accordance with claim 12, wherein the independent variables comprise at least one of a spatial, non-spatial and temporal independent variable type determined to be at, or within a predefined proximity of, the geographical reference.
